(19) United States
(12) Patent Application Publication
(10) Pub. No.: US 2026/0051649 A1
(43) Pub. Date: Feb. 19, 2026

(54) ELECTRONIC DEVICE COMPRISING FLEXIBLE DISPLAY

(71) Applicant: Samsung Electronics Co., Ltd., Suwon-si (KR)

(72) Inventors: Junghoon SEO, Suwon-si (KR); Moonyung KIM, Suwon-si (KR)

(21) Appl. No.: 19/302,642

(22) Filed: Aug. 18, 2025

Related U.S. Application Data
(63) Continuation of application No. PCT/KR2025/012478, filed on Aug. 18, 2025.

(30) Foreign Application Priority Data
Aug. 16, 2024 (KR) 10-2024-0110052
Oct. 11, 2024 (KR) 10-2024-0138360

(51) Int. Cl. H01Q 1/24; H01Q 1/38; H04M 1/02

(52) U.S. Cl. CPC H01Q 1/243; H01Q 1/38; H04M 1/0235; H04M 1/0268; H04M 1/0277

(57) ABSTRACT

An electronic device is provided. The electronic device includes a housing including a first housing part, and a second housing part configured to move slidably with respect to the first housing part between a slide-in state and a slide-out state, a flexible display comprising a first region and a second region, wherein at least part of the second region is drawn into or withdrawn from an internal space of the housing according to a movement of the second housing part with respect to the first housing part, a multi-bar structure disposed to support the at least part of the second region of the flexible display and including a plurality of bars and a plurality of gaps being defined between two adjacent bars among the plurality of bars, wherein each of the plurality of bars includes a conductive material and an antenna including a plurality of first patterns arranged parallel to a lengthwise direction of one of the plurality of bars, wherein the antenna is configured to be disposed within a space formed between a portion of the first region and a portion of the second region of the flexible display in the slide-in state and each of the plurality of first patterns is configured to be aligned with a corresponding gap of the plurality of gaps for radiating signal from the antenna through the plurality of gaps in the slide-in state.

### CROSS-REFERENCE TO RELATED APPLICATION(S)

This application is a continuation application, claiming priority under 35 U.S.C. § 365(c), of an International application No. PCT/KR2025/012478, filed on Aug. 18, 2025, which is based on and claims the benefit of a Korean patent application number 10-2024-0110052, filed on Aug. 16, 2024, in the Korean Intellectual Property Office, and of a Korean patent application number 10-2024-0138360, filed on Oct. 11, 2024, in the Korean Intellectual Property Office, the disclosure of each of which is incorporated by reference herein in its entirety.

### BACKGROUND

### 1. Field

The disclosure relates to an electronic device. More particularly, the disclosure relates to an electronic device including a flexible display.

### 2. Description of Related Art

The term “electronic device” may mean a device performing a particular function according to its equipped program, such as a home appliance, an electronic scheduler, a portable multimedia player, a mobile communication terminal, a tablet PC, a video/sound device, a desktop PC or laptop computer, a navigation for automobile, etc. For example, the electronic devices may output stored information as voices or images. As electronic devices are highly integrated, and high-speed, high-volume wireless communication becomes commonplace, an electronic device, such as a mobile communication terminal, is recently being equipped with various functions. For example, an electronic device comes with the integrated functionality, including an entertainment function, such as playing video games, a multimedia function, such as replaying music/videos, a communication and security function for mobile banking, and a scheduling or e-wallet function. These electronic devices have been downsized to be conveniently carried by users.

As mobile communication services extend to multimedia service areas, multimedia services as well as voice calls or short text messages are provided to users. To rid the user of any inconvenience in using multimedia services, a trend is to pack an electronic device with a larger display panel. Recently, the electronic devices equipped with flexible displays have been disclosed. An electronic device equipped with a flexible display includes, e.g., a foldable electronic device or a rollable electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a flexible display.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a first housing part, and a second housing part configured to move slidably with respect to the first housing part between a slide-in state and a slide-out state, a flexible display comprising a first region and a second region, wherein at least part of the second region is drawn into or withdrawn from an internal space of the housing according to a movement of the second housing part with respect to the first housing part, a multi-bar structure disposed to support the at least part of the second region of the flexible display and including a plurality of bars and a plurality of gaps being defined between two adjacent bars among the plurality of bars, wherein each of the plurality of bars includes a conductive material and an antenna including a plurality of first patterns arranged parallel to a lengthwise direction of one of the plurality of bars wherein the antenna is configured to be disposed within a space formed between a part of the first region and a part of the second region of the flexible display in the slide-in state, and each of the plurality of first patterns is configured to be aligned with a corresponding gap of the plurality of gaps for radiating signal from the antenna through the plurality of gaps in the slide-in state.

In accordance with another aspect of the disclosure, a slidable electronic device is provided. The slidable electronic device includes a housing including a first housing part, and a second housing part configured to move in a first direction with respect to the first housing part, a flexible display configured to be moved based on movement of the second housing part, a multi-bar structure configured to support at least a portion of the flexible display and including a plurality of bars, an antenna including a plurality of first patterns extending in a second direction perpendicular to the first direction, and a plurality of second patterns extending in a direction different from the plurality of first patterns, Wherein the antenna is disposed inside the flexible display, and wherein the plurality of first patterns of the antenna are disposed at positions corresponding to a plurality of gaps between two adjacent bars among the plurality of bars included in the multi-bar structure when the slidable electronic device is in a slide-in state.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a view illustrating a state in which a second region of a display is stored inside an electronic device according to an embodiment of the disclosure;

FIG. 3 is a view illustrating a state in which a second region of a display is visually exposed to the outside of an electronic device according to an embodiment of the disclosure;

FIG. 4 is an exploded perspective view illustrating an electronic device according to an embodiment of the disclosure;

FIG. 5A is a cross-sectional view taken along line A-A′ of FIG. 2 according to an embodiment of the disclosure;

FIG. 5B is a cross-sectional view taken along line B-B′ of FIG. 3 according to an embodiment of the disclosure;

FIG. 6A is an enlarged view illustrating a portion of an electronic device according to an embodiment of the disclosure;

FIG. 6B is an enlarged view illustrating a portion of an electronic device according to an embodiment of the disclosure;

FIG. 7A is an enlarged view illustrating a portion of an electronic device according to an embodiment of the disclosure;

FIG. 7B is an enlarged view illustrating a portion of an electronic device according to an embodiment of the disclosure;

FIG. 8 is a view illustrating an inside of an electronic device according to an embodiment of the disclosure;

FIG. 9 is a view illustrating an arrangement relationship of a battery, a circuit board, and a multi-bar structure according to an embodiment of the disclosure;

FIG. 10 is a view illustrating a gap between two adjacent bars among a plurality of bars included in a multi-bar structure according to an embodiment of the disclosure;

FIG. 11 is a view illustrating an arrangement relationship of a circuit board, a multi-bar structure, and an antenna according to an embodiment of the disclosure;

FIG. 12 is a view illustrating a plurality of first patterns of an antenna disposed at positions corresponding to gaps between two adjacent bars among a plurality of bars included in a multi-bar structure according to an embodiment of the disclosure;

FIG. 13 is a view illustrating an arrangement relationship of a circuit board, a multi-bar structure, and an antenna pattern according to an embodiment of the disclosure;

FIG. 14 is a view illustrating an arrangement relationship of a circuit board, a multi-bar structure, and an antenna pattern according to an embodiment of the disclosure;

FIG. 15 is a view illustrating an arrangement relationship of a lattice structure, multi-bars, and an antenna according to an embodiment of the disclosure;

FIG. 16 is an enlarged view illustrating a lattice structure, multi-bars, and an antenna according to an embodiment of the disclosure;

FIG. 17 is a view illustrating gaps between two adjacent bars among a plurality of bars included in a multi-bar structure and slits of a lattice structure disposed corresponding thereto according to an embodiment of the disclosure;

FIG. 18A is an enlarged view illustrating a multi-bar structure and an antenna according to an embodiment of the disclosure;

FIG. 18B is an enlarged view illustrating a multi-bar structure and an antenna according to an embodiment of the disclosure;

FIG. 18C is an enlarged view illustrating a multi-bar structure and an antenna according to an embodiment of the disclosure;

FIG. 19 is a view illustrating a view illustrating a multi-bar structure from above according to an embodiment of the disclosure;

FIG. 20 is a view illustrating an arrangement relationship of a multi-bar structure and a guide rail according to an embodiment of the disclosure;

FIG. 21 is an enlarged view illustrating an arrangement relationship of a multi-bar structure and a guide rail according to an embodiment of the disclosure;

FIG. 22A is a cross-sectional view illustrating a multi-bar structure and a lattice structure according to an embodiment of the disclosure; and

FIG. 22B is a cross-sectional view illustrating a multi-bar structure and a dielectric material according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

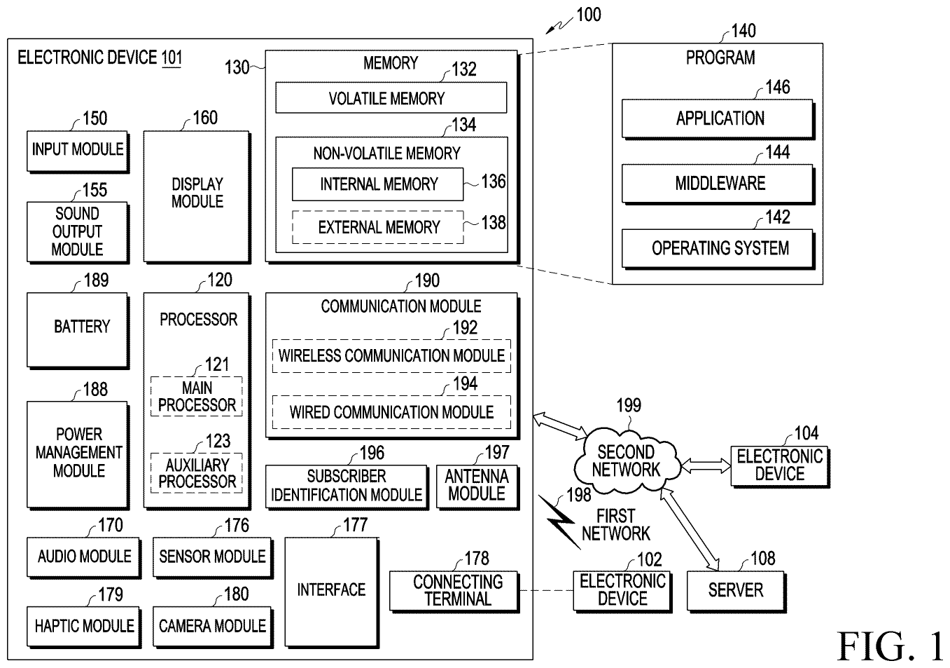

FIG. 1 is a block diagram illustrating an electronic device in a network environment according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

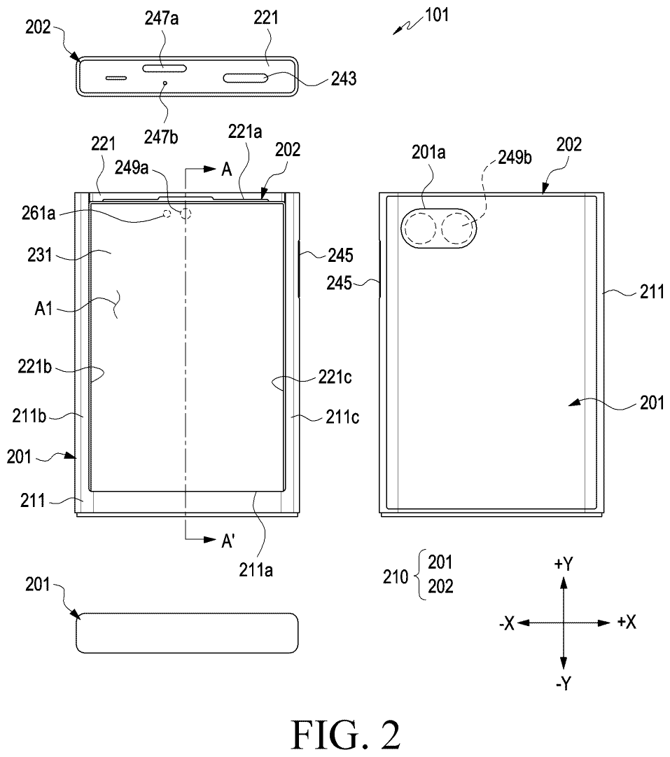

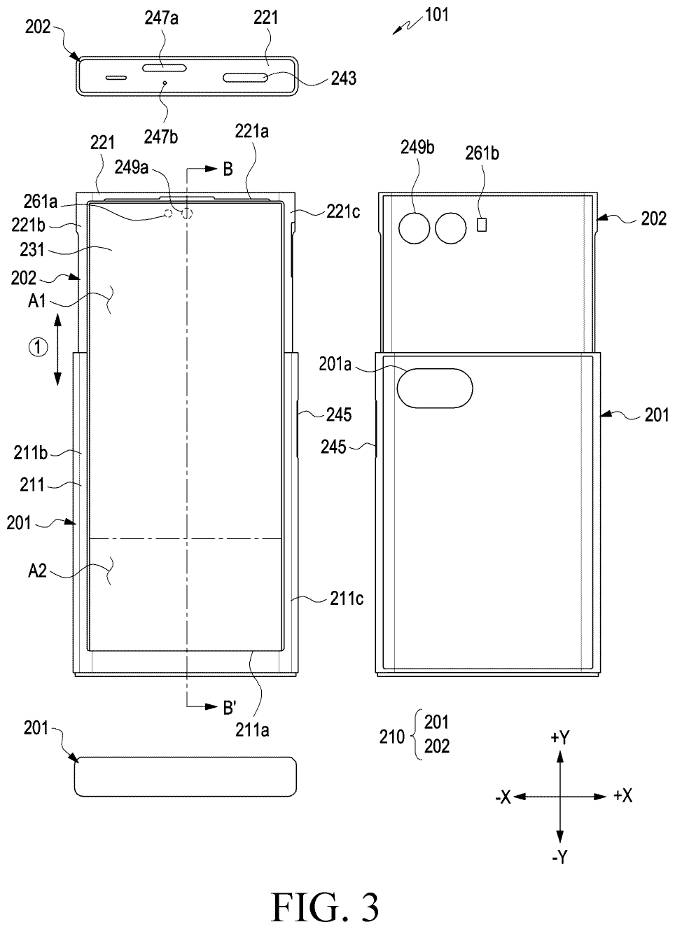

FIG. 2 is a view illustrating a state in which a second region A2 of a display (e.g., the second region A2 of FIG. 3) is stored inside an electronic device 101 according to an embodiment of the disclosure. A second region A2 extending from a first region A1 may be at least partially hidden inside the electronic device in a different plane from the first region A1.

FIG. 3 is a view illustrating a state in which a second region A2 of a display is visually exposed to the outside of an electronic device according to an embodiment of the disclosure. A second region A2 extending from a first region A1 may be at least partially visually shown to the outside of the electronic device in substantially the same plane as the first region, based on movement of a second housing part.

According to an embodiment of the disclosure, a display 231 may include a first region A1 and a second region A2 at least partially retracted into or extracted from an inner space of the housing. According to an embodiment, in the embodiment illustrated in FIG. 2, a screen display area may correspond to the first region A1, and in the embodiment illustrated in FIG. 3, a screen display area may correspond to the first region A1 and the second region A2 that is newly visually exposed.

FIGS. 2 and 3 illustrate a structure in which the display 231 (e.g., flexible display or rollable display) is extended in the lengthwise direction (e.g., +Y direction) when the electronic device 101 is viewed from the front. However, the extending direction of the display 231 is not limited to one direction (e.g., +Y direction). For example, the extending direction of the display 231 may be changed in design to be extendable in the upper direction (e.g., +Y direction), right direction (e.g., +X direction), left direction (e.g., −X direction), and/or lower direction (e.g., −Y direction). Descriptions of components of the disclosure may be made based on an X-axis, Y-axis, and Z-axis of an XYZ orthogonal coordinate system. In describing directions of the disclosure, negative (−)/positive (+) directions may be additionally mentioned, and unless specifically mentioned, when negative (−)/positive (+) directions are not described together, the direction may be interpreted to include both negative (−) and positive (+) directions. In the disclosure, a movement direction of a second housing 202 with respect to a first housing 201 (or a movement direction of the first housing 201 with respect to the second housing 202) may be parallel to the +Y axis or −Y axis. In the disclosure, when a component is disposed on another component, the reference may be the Z axis. In the disclosure, a first direction may mean a direction parallel to the −Y axis, and a second direction may mean a direction parallel to the +Y axis. A third direction may mean a direction parallel to the +X axis or a direction parallel to the −X axis that is perpendicular to the +Y axis and −Y axis. For example, in the following embodiments, “lengthwise direction of a bar” may mean the third direction parallel to the +X axis or −X axis.

The state illustrated in FIG. 2 may represent a state in which the second region A2 is hidden inside the electronic device. For example, the state illustrated in FIG. 2 may be referred to as a slide-in state of the electronic device 101 (and/or the second region A2 of the display 231). The state illustrated in FIG. 2 may represent a state in which the second region is completely hidden inside the electronic device. For example, the state illustrated in FIG. 2 may be referred to as a fully slide-in state of the electronic device 101 (and/or the second region A2 of the display 231). The state illustrated in FIG. 2 may alternatively be referred to as a closed state of the electronic device 101 (and/or the second region A2 of the display 231). The state illustrated in FIG. 2 may also be referred to as a fully closed state of the electronic device 101 (and/or the second region A2 of the display 231).

The state illustrated in FIG. 3 may represent a state in which the area visually exposed to the outside of the electronic device in substantially the same plane as the first region is maximized. For example, the state illustrated in FIG. 3 may be referred to as a slide-out state of the electronic device 101, or an opened state of the second region A2 of the display 231. The state illustrated in FIG. 3 may also be referred to as a fully opened state of the electronic device 101 (and/or the second region A2 of the display 231). Referring to FIGS. 2 and 3, an electronic device 101 (e.g., the electronic device 101 of FIG. 1) may include a housing 210. The housing 210 may have an angular appearance as illustrated in FIGS. 2 and 3. However, it is not necessarily limited thereto, and the appearance of the housing 210 may be at least partially curved, and may have an appearance in which surfaces facing different directions are seamlessly connected. The housing 210 may include a first housing part 201 and a second housing part 202 disposed to be movable relative to the first housing part 201. According to an embodiment, a first housing part 201 may be referred to as a “first housing,” and a second housing part 202 may be referred to as a “second housing.” The electronic device 101 may be referred to as a “rollable electronic device” or a “slidable electronic device” in that some housing parts are movable.

The electronic device 101 of the disclosure may have a structure in which the second housing part 202 moves slidably with respect to the first housing part 201 in a slide-in state and a slide-out state. However, the disclosure is not necessarily limited to embodiments in which the second housing part 202 moves with respect to the first housing part 201. For example, the disclosure may also include a structure in which the first housing part 201 is disposed to be slidably movable with respect to the second housing part 202 in the electronic device 101. In the following embodiments, descriptions will focus on embodiments in which the second housing part 202 moves with respect to the first housing part 201, but it should be noted that such descriptions may also apply to embodiments in which the first housing part 201 moves with respect to the second housing part 202. According to an embodiment, the second housing part 202 may be disposed to perform reciprocating motion by a predetermined distance in a predetermined direction with respect to the first housing part 201, for example, a direction indicated by an arrow \textcircled{1} of FIG. 3.

According to an embodiment, the second housing part 202 may be referred to as a slide portion or a slide housing, and may be movable relative to the first housing part 201. According to an embodiment, the second housing part 202 may receive various electrical and electronic components, such as a circuit board (e.g., printed circuit board) or a battery. When the electronic device 101 is in the slide-in state, the second housing part 202 may be defined as being at a retracted position, and when the electronic device 101 is in the slide-out state, the second housing part 202 may be defined as being at an extended position. For example, the second housing part 202 may be configured to move between the retracted position and the extended position with respect to the first housing part 201.

According to an embodiment, the slide-in state of the electronic device 101 (or the slide-out state of the electronic device 101) may be changed into the slide-out state of the electronic device 101 (or the slide-in state of the electronic device 101) based on a predefined user input and/or a preset operation state of the electronic device. Information about the predefined user input and/or preset operation state of the electronic device may be stored in memory of the electronic device (e.g., the memory 130 of FIG. 1).

There may be various examples of the user input. For example, the slide-in state of the electronic device 101 (or the slide-out state of the electronic device 101) may be changed into the slide-out state (or the slide-in state of the electronic device 101) in response to a user input to a physical button exposed through a portion of the first housing part 201 or a portion of the second housing part 202. For example, the slide-in state (or the slide-out state of the electronic device 101) may be changed into the slide-out state (or the slide-in state of the electronic device 101) in response to a touch input to an executable object displayed in the screen display area (e.g., the first region A1). For example, the slide-in state (or the slide-out state of the electronic device 101) may be changed into the slide-out state (or the slide-in state of the electronic device 101) in response to a touch input having a pressing strength of a reference strength or more at a contact point on the screen display area (e.g., the first region A1). For example, the slide-in state (or the slide-out state of the electronic device 101) may be changed into the slide-out state (or the slide-in state of the electronic device 101) in response to a voice input received through the microphone of the electronic device 101. For example, the slide-in state (or the slide-out state of the electronic device 101) may be changed into the slide-out state (or the slide-in state of the electronic device 101) in response to an external force applied to the first housing part 201 and/or the second housing part 202 to move the second housing part 202 with respect to the first housing part 201. For example, the slide-in state (or the slide-out state of the electronic device 101) may be changed into the slide-out state (or the slide-in state of the electronic device 101) in response to a user input identified from an external electronic device (e.g., earbuds or a smart watch) connected with the electronic device 101. However, examples of the user input that causes the slide-in/out operation of the electronic device 101 are not limited thereto.

Examples of the operation state of the electronic device may vary. For example, a slide-in state of the electronic device 101 (or a slide-out state of the electronic device 101) may be changed to a slide-out state (or a slide-in state of the electronic device 101) according to an operation state of the electronic device based on tilt information from a sensor (e.g., a gyro sensor) provided in the electronic device. For example, a slide-in state of the electronic device 101 (or a slide-out state of the electronic device 101) may be changed to a slide-out state (or a slide-in state of the electronic device 101) according to an operation state of the electronic device related to the charge amount of battery power of the electronic device (e.g., when the charge amount of battery power is less than 1%, it changes from a slide-out state to a slide-in state). However, examples of the operation state of the electronic device that causes the slide-in/out operation of the electronic device 101 are also not limited thereto.

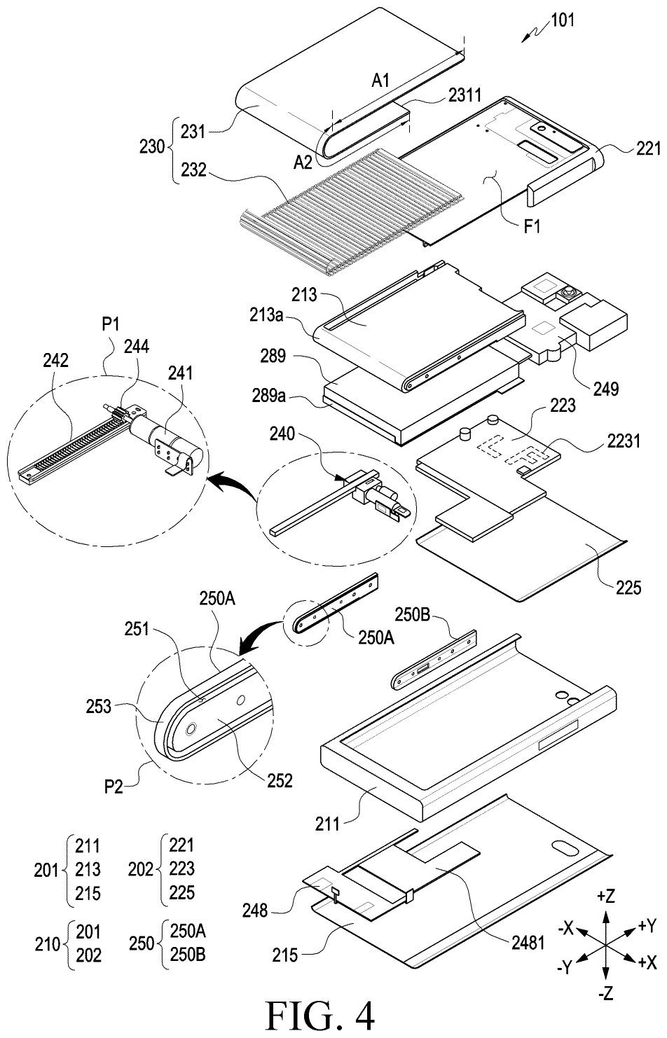

According to an embodiment, the first housing part 201 may receive an actuator (e.g., a motor), a speaker, a SIM socket, and/or a sub circuit board (e.g., the first circuit board 248 of FIG. 4) electrically connected to a main circuit board (e.g., the second circuit board 249 of FIG. 4). The second housing part 202 may receive a main circuit board on which electric components, such as an application processor (AP) or a communication processor (CP) are mounted. According to an embodiment, the second housing part 202 may receive the actuator, speaker, sim socket, and/or the sub circuit board electrically connected with the main circuit board, and the first housing part 201 may receive the main circuit board where electrical components, such as an application processor (AP) or a communication processor (CP), are mounted. However, the disclosure is not limited to the above-described embodiment. According to an embodiment, a sub circuit board (e.g., the first circuit board 248 of FIG. 4) may be disposed in the second housing part 202, and a main circuit board (e.g., the second circuit board 249 of FIG. 4) may be disposed in the first housing part 201.

According to an embodiment, referring to FIGS. 2 and 3, the first housing part 201 may include a first cover member 211. According to an embodiment, the first cover member 211 may be referred to as a main cover, a fixed cover, or a rear cover. According to an embodiment, the first cover member 211 may be referred to as a main plate or a fixed plate. The first cover member 211 may include a 1-1th sidewall 211a, a 1-2th sidewall 211b extending from the 1-1th sidewall 211a, and a 1-3th sidewall 211c extending from the 1-1th sidewall 211a and substantially parallel to the 1-2th sidewall 211b. According to an embodiment, the 1-2th sidewall 211b and the 1-3th sidewall 211c may be formed substantially perpendicular to the 1-1th sidewall 211a.

According to an embodiment, the 1-1th sidewall 211a, 1-2th sidewall 211b, and 1-3th sidewall 211c of the first cover member 211 may be formed to have an opening in a side surface (e.g., a front surface or front face) to receive (or surround) at least a portion of the second housing part 202. For example, at least a portion of the second housing part 202 is surrounded by the first housing part 201, and while being guided by the first housing part 201, may slide in a direction perpendicular to a direction that a first surface (e.g., the first surface F1 of FIG. 4) faces, e.g., in a first direction or a second direction (arrow \textcircled{1} direction) opposite to the first direction. According to an embodiment, the 1-1th sidewall 211a, the 1-2th sidewall 211b, and/or the 1-3th sidewall 211c of the first cover member 211 may be integrally formed. According to an embodiment, the 1-1th sidewall 211a, the 1-2th sidewall 211b, and/or the 1-3th sidewall 211c of the first cover member 211 may be formed as separate structures and be combined or assembled.

According to an embodiment, the first cover member 211 may be formed to surround at least a portion of the display 231. For example, at least a portion of the display 231 may be formed to be surrounded by the 1-1th sidewall 211a, the 1-2th sidewall 211b, and/or the 1-3th sidewall 211c of the first cover member 211.

According to an embodiment, the second housing part 202 may include a second cover member 221. The second cover member 221 may have a plate shape and include a first surface (e.g., the first surface F1 of FIG. 4) supporting internal components. For example, the second cover member 221 may support at least a portion of the display 231 (e.g., the first region A1). According to an embodiment, the second cover member 221 may be referred to as a slide cover or a front cover. According to an embodiment, the second cover member 221 may be referred to as a slide plate or a front plate.

According to an embodiment, the second cover member 221 may include a 2-1th sidewall 221a, a 2-2th sidewall 221b extending from the 2-1th sidewall 221a, and a 2-3th sidewall 221c extending from the 2-1th sidewall 221a and substantially parallel to the 2-2th sidewall 221b. According to an embodiment, the 2-2th sidewall 221b and the 2-3th sidewall 221c may be formed substantially perpendicular to the 2-1th sidewall 221a.

According to an embodiment, the second housing part 202 may form a slide-in state or slide-out state of the electronic device 101 by moving in a first direction parallel to a 2-2th side wall 221b or a 2-3th side wall 221c, or in a second direction (e.g., \textcircled{1} direction of FIG. 3) opposite to the first direction. In the slide-in state of the electronic device 101, the second housing part 202 may be positioned at a first distance from the 1-1th sidewall 211a of the first housing part 201. In the slide-out state of the electronic device 101, the second housing part 202 may move to be positioned at a second distance larger than the first distance from the 1-1th sidewall 211a of the first housing part 201. In an embodiment, in the slide-in state of the electronic device 101, the first housing part 201 may be formed to surround a portion of the 2-2th sidewall 221b and the 2-3th sidewall 221c.

According to an embodiment, the second housing part 202 may be configured to move between a first position (e.g., FIG. 2) and a second position (e.g., FIG. 3) with respect to the first housing part 201. For example, referring to FIGS. 2 and 3, the electronic device slides out by the second housing part 202 moving in the +Y-axis direction with respect to the first housing part 201, and the electronic device slides in by the second housing part 202 moving in the −Y-axis direction with respect to the first housing part 201, but it is not necessarily limited thereto. Although not illustrated in the drawings of the disclosure, embodiments may also be included in which the electronic device slides out by the first housing part 201 moving in the −Y-axis direction with respect to the second housing part 202, and the electronic device slides in by the first housing part 201 moving in the +Y-axis direction with respect to the second housing part 202. Hereinafter, embodiments in which the second housing part 202 slides with respect to the first housing part 201 may be mainly described, and descriptions thereof may apply to embodiments in which the first housing part 201 slides with respect to the second housing part 202. According to an embodiment, the electronic device 101 may have an intermediate state between the slide-in state of FIG. 2 (e.g., fully closed state) and the slide-out state of FIG. 3 (e.g., fully opened state). The distance between the 1-1th sidewall 211a and the 2-1th sidewall 221a in the intermediate state of the electronic device 101 may be shorter than the distance between the 1-1th sidewall 211a and the 2-1th sidewall 221a of the electronic device 101 in the fully opened state and be longer than the distance between the 1-1th sidewall 211a and the 2-1th sidewall 221a of the electronic device 101 in the fully closed state. According to an embodiment, as at least a portion of the display 231 slides in the intermediate state of the electronic device 101, the area exposed to the outside may vary. For example, in the intermediate state of the electronic device 101, the ratio of the width (e.g., length in the X direction) to the height (e.g., length in the Y direction) of the display 231 and/or the distance between the 1-1th sidewall 211a and the 2-1th sidewall 221a may be changed based on the slide of the electronic device 101.

According to an embodiment, the electronic device 101 may include a display 231, a key input device 245, a connector hole 243, audio modules 247a and 247b, or camera modules 249a and 249b. According to an embodiment, the electronic device 101 may further include an indicator (e.g., a light emitting diode (LED) device) or various sensor modules.

According to an embodiment, the display 231 may be formed so that the size of a portion of the housing 210, which may be viewed from the front, is changed based on the slide of the second housing part 202. According to an embodiment, the display 231 may include a first region A1 and a second region A2 configured to be exposed to the outside of the electronic device 101 based on the slide of the second housing part 202. The first region A1 may be referred to as a first display area. The second region A2 may be referred to as a second display area. Based on movement of the second housing part 202 with respect to the first housing part 201, at least a portion of the second region A2 may be configured to be bent.

According to an embodiment, as the second housing part 202 moves between the retracted position and the extended position with respect to the first housing part 201, the size of the display 231 viewed through the external front surface (front face) of the electronic device 101 may be varied. For example, when the second housing part 202 is positioned at a retracted position with respect to the first housing part 201 (e.g., FIG. 2), a size (or area) of the display 231 shown to an external front side of the electronic device 101 may be substantially minimized. Further, when the second housing part 202 is positioned at an extended position with respect to the first housing part 201 (e.g., FIG. 3), a size (or area) of the display 231 shown to an external front side of the electronic device 101 may be substantially maximized.

According to an embodiment, the first region A1 may be disposed on the second housing part 202. For example, the first region A1 may be disposed on a second cover member 221 of the second housing part 202. According to an embodiment, the second region A2 extends from the first region A1, and as the second housing part 202 slides with respect to the first housing part 201, may be stored inside the first housing part 201 or may be visually exposed to the outside of the electronic device 101.

Referring to FIG. 3, according to an embodiment of the disclosure, as the electronic device 101 changes from a slide-in state to a slide-out state, the display 231 may extend in a downward direction (e.g., −Y direction) of the electronic device 101. For example, in a slide-in state of the electronic device 101, the second region A2 may be visually exposed in a downward direction (e.g., −Y direction) of the display 231. For example, in a slide-out state of the electronic device 101, the second region A2 may be visually exposed between the first region A1 of the display 231 and a 1-1th side wall 211a of the first housing part 201. However, the disclosure is not necessarily limited to the embodiment illustrated in FIG. 3. Unlike what is illustrated in FIG. 3, according to an embodiment, as the electronic device 101 changes from a slide-in state to a slide-out state, the display 231 may extend in an upward direction (e.g., +Y direction) of the electronic device 101. For example, in a slide-out state of the electronic device 101, the second region A2 may be visually exposed in an upward direction (e.g., +Y direction) of the display 231. For example, in a slide-out state of the electronic device 101, the second region A2 may be visually exposed between the first region A1 of the display 231 and a 2-1th side wall 221a of the second housing part 202.

According to an embodiment, the second region A2 substantially moves while being guided by one area (e.g., the guide rail 250 of FIG. 4) of the first housing part 201, and may be stored in a space positioned inside the first housing part 201 or exposed to the outside of the electronic device 101. According to an embodiment, the second region A2 may move based on sliding movement of the second housing part 202 in a first direction or a second direction (e.g., a direction indicated by arrow (1)) opposite to the first direction. According to an embodiment, the second region A2 may be deformed in shape based on sliding movement of the second housing part 202 in a first direction or a second direction (e.g., a direction indicated by arrow opposite to the first direction. For example, while the second housing part 202 slides, a portion of the second region A2 may have a flat shape. For example, while the second housing part 202 slides, a portion of the second region A2 may have a curved shape at a position corresponding to the curved surface 213a (e.g., curved portion) of the first housing part 201. According to an embodiment, a portion of the exposed second region A2 of the electronic device 101 may be positioned on a portion (e.g., the curved surface 213a of FIG. 4) of the first housing part, and another portion of the second region A2 disposed at a position corresponding to the curved surface 213a may maintain a curved shape.

According to an embodiment, when viewed from an upper portion of the second cover member 221 (e.g., front cover) (e.g., +Z direction or front direction of the electronic device), when the electronic device 101 changes from a slide-in state to a slide-out state (e.g., when the second housing part 202 slides to extend with respect to the first housing part 201), the second region A2 may gradually be exposed to the outside of the first housing part 201 and form substantially the same plane together with the first region A1.

According to an embodiment, the display 231 may be coupled with or disposed adjacent to a touch detection circuit, a pressure sensor capable of measuring the strength (pressure) of touches, and/or a digitizer for detecting a magnetic field-type stylus pen.

According to an embodiment, the key input device 245 may be positioned in an area of the housing 210 (e.g., the first housing part 201 and/or second housing part 202). Depending on the appearance and the state of use, the electronic device 101 may be designed to omit the illustrated key input device 245 or to include additional key input device(s). According to an embodiment, the electronic device 101 may include a key input device (not shown), e.g., a home key button or a touchpad disposed around the home key button. According to an embodiment, at least a portion of the key input device 245 may be disposed on the 1-1th sidewall 211a, the 1-2th sidewall 211b, or the 1-3th sidewall 211c of the first housing part 201. According to an embodiment, at least a portion of the key input device 245 may be disposed on the 2-1th sidewall 221a, the 2-2th sidewall 221b, and/or the 2-3th sidewall 221c of the second housing part 202.

According to an embodiment, the connector hole 243 may be omitted or may accommodate a connector (e.g., a universal serial bus (USB) connector) for transmitting and receiving power and/or data with an external electronic device. According to an embodiment, the electronic device 101 may include a plurality of connector holes 243, and some of the plurality of connector holes 243 may function as connector holes for transmitting/receiving audio signals with an external electronic device. In the illustrated embodiment, the connector hole 243 is disposed in the second housing part 202, but is not limited thereto. For example, the connector hole 243 or a connector hole not shown may be disposed in the first housing part 201.

According to an embodiment, the audio modules 247a and 247b may include at least one speaker hole 247a or at least one microphone hole 247b. One of the speaker holes 247a may be provided as a receiver hole for voice calls, and the other may be provided as an external speaker hole. The electronic device 101 may include a microphone for obtaining sound. The microphone may obtain external sound of the electronic device 101 through the microphone hole 247b. According to an embodiment, the electronic device 101 may include a plurality of microphones to detect the direction of sound. According to an embodiment, the electronic device 101 may include an audio module in which the speaker hole 247a and the microphone hole 247b are implemented as one hole or may include a speaker without the speaker hole 247a (e.g., a piezo speaker). According to an embodiment, the speaker hole 247a and the microphone hole 247b may be positioned in the first housing part 201 and/or the second housing part 202.

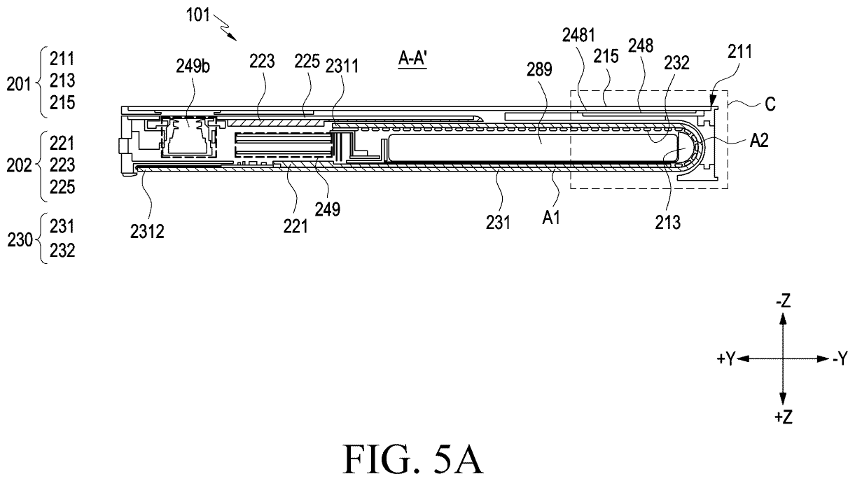

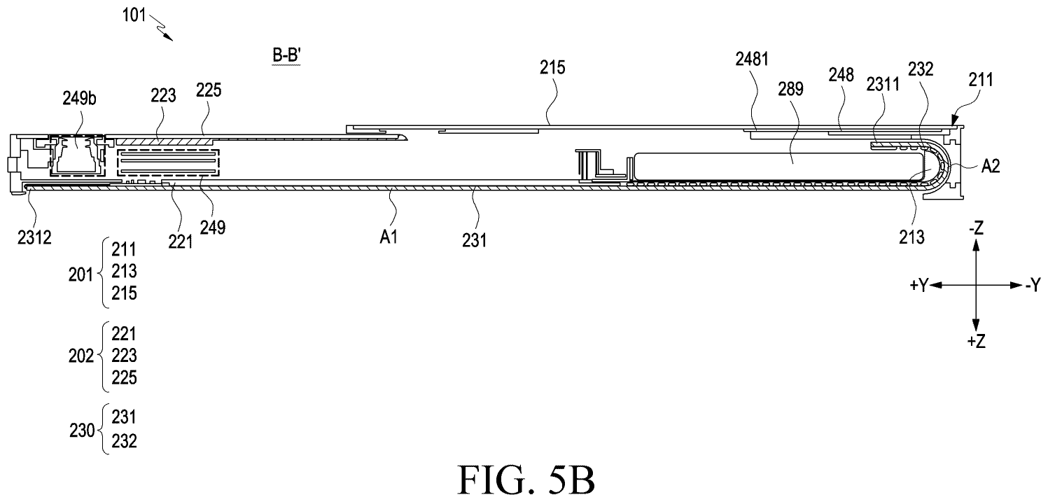

According to an embodiment, the camera modules 249a and 249b may include a first camera module 249a (e.g., a front camera) and a second camera module 249b (e.g., a rear camera) (e.g., the second camera module 249b of FIGS. 5A and 5B). According to an embodiment, the electronic device 101 may include at least one of a wide-angle camera, a telephoto camera, or a close-up camera. According to an embodiment, the electronic device 200 may measure the distance to the subject by including an infrared projector and/or an infrared receiver. The camera modules 249a and 249b may include one or more lenses, an image sensor, and/or an image signal processor. The first camera module 249a may be disposed to face in the same direction as the display 231. For example, the first camera module 249a may be disposed in an area around the first region A1 or overlapping the display 231. When disposed in the area overlapping the display 231, the first camera module 249a may capture the subject through the display 231. According to an embodiment, the first camera module 249a may include an under display camera (UDC) that has a screen display area (e.g., the first region A1) that may not be visually exposed but hidden. According to an embodiment, the second camera module 249b may capture the subject in a direction opposite to the first region A1. According to an embodiment, the first camera module 249a and/or the second camera module 249b may be disposed on the second housing part 202. According to an embodiment, a plurality of second camera modules 249b may be formed to provide various arrays. For example, the plurality of second camera modules 249b may be arranged along a width direction (X-axis direction) that is substantially perpendicular to the sliding direction (e.g., Y-axis direction) of the electronic device 101. According to an embodiment, the plurality of second camera modules 249b may be arranged along the sliding direction (e.g., Y-axis direction) of the electronic device 101. According to an embodiment, a plurality of second camera modules 249b may be arranged in an N*M matrix form (e.g., N rows*M columns).

Referring to FIG. 3, the second camera module 249b may be configured not to be visually exposed to the outside of the electronic device 101 in a slide-in state of the electronic device 101, and to be visually exposed to the outside of the electronic device 101 to capture the outside in a slide-out state of the electronic device 101. However, it is not necessarily limited thereto, and according to an embodiment, the second camera module 249b may be configured to capture the outside of the electronic device 101 in a slide-in state and/or slide-out state of the electronic device 101. For example, at least a portion (e.g., the first rear plate 215 and/or the second rear plate 225 of FIG. 4) of the housing 210 is substantially transparent, and the second camera module 249b may capture the outside of the electronic device 101 through the first rear plate 215 and/or the second rear plate 225. According to an embodiment, the second camera module 249b may be configured to be visually exposed to the outside of the electronic device 101 in both slide-in and slide-out states of the electronic device 101 to capture the outside. For example, the first housing part 201 (e.g., the first rear plate 215 of FIG. 4) may include an opening 201a for the second camera module 249b.

According to an embodiment, an indicator (not shown) of the electronic device 101 may be disposed on the first housing part 201 or the second housing part 202, and the indicator may include a light emitting diode to provide state information about the electronic device 101 as a visual signal. The sensor module 261a or 261b of the electronic device 101 may produce an electrical signal or data value corresponding to the internal operation state or external environment state of the electronic device. The sensor module 261a or 261b may include a proximity sensor, a fingerprint sensor, and/or a biometric sensor (e.g., an iris/face recognition sensor or a heartrate monitor (HRM) sensor). According to an embodiment, the sensor module 261a or 261b may further include, e.g., at least one of a gesture sensor, a gyro sensor, an atmospheric pressure sensor, a magnetic sensor, an acceleration sensor, a grip sensor, a color sensor, an infrared (IR) sensor, a temperature sensor, a humidity sensor, or an illuminance sensor. According to an embodiment, the sensor module 261a or 261b may be disposed in the first housing part 201 and/or the second housing part 202. The sensor modules 261a and 261b may include a first sensor module 261a (e.g., proximity sensor or illuminance sensor) disposed on the front surface of the electronic device 101 and/or a second sensor module 261b (e.g., heart rate monitoring (HRM) sensor) disposed at the rear of the electronic device 101.

FIG. 4 is an exploded perspective view illustrating an electronic device according to an embodiment of the disclosure.

FIG. 5A is a cross-sectional view taken along line A-A′ of FIG. 2 according to an embodiment of the disclosure.

FIG. 5B is a cross-sectional view taken along line B-B′ of FIG. 3 according to an embodiment of the disclosure.

Referring to FIG. 4, FIG. 5A, and/or FIG. 5B, an electronic device 101 (e.g., the electronic device 101 of FIGS. 1 to 3) may include a housing 210, a first housing part 201, a second housing part 202, a display assembly 203, and a driving module 240. The configuration of the first housing part 201, the second housing part 202, and the display assembly 230 of FIGS. 4, 5A, and/or 5B may be identical in whole or part to the configuration of the housing 210, the first housing part 201, the second housing part 202, and the display 231 of FIGS. 2 and/or 3. In describing the embodiments of FIGS. 4, 5A, and 5B, content overlapping content described above in the embodiments of FIGS. 1 to 3 may be omitted.

According to an embodiment, the housing 210 may include a first housing part 201, or a second housing part 202 configured to slidably move between a slide-in state and a slide-out state with respect to the first housing part 201.

According to an embodiment, the first housing part 201 may include a first cover member 211 (e.g., the first cover member 211 of FIGS. 2 and 3), a frame 213, and a first rear plate 215.

According to an embodiment, the first cover member 211 may accommodate at least a portion of the frame 213 and accommodate a component (e.g., battery 289) positioned in the frame 213. According to an embodiment, the first cover member 211 may be formed to surround at least a portion of the second housing part 202. According to an embodiment, the first cover member 211 may protect the components (e.g., the second circuit board 249 and the frame 213) positioned in the first housing part 201 from external impact. According to an embodiment, the second circuit board 249 electrically connected with an electric component (e.g., an actuator, a speaker, a sim socket, and/or the first circuit board 248) may be connected to the first cover member 211.

According to an embodiment, the frame 213 may be connected to the first cover member 211. For example, the frame 213 may be connected to the first cover member 211. The second housing part 202 is movable relative to the first cover member 211 and/or the frame 213. According to an embodiment, the frame 213 may accommodate the battery 289. For example, the frame 213 may include a recess for receiving the battery 289. The frame 213 may be connected to the battery cover 289a and, together with the battery cover 289a, may surround at least a portion of the battery 289. According to an embodiment, the frame 213 may include a curved surface 213a facing a display assembly 230.

According to an embodiment, the first rear plate 215 may substantially form at least a portion of an appearance of the first housing part 201 or the electronic device 101. For example, the first rear plate 215 may be coupled to an outer surface of the first cover member 211. According to an embodiment, the first rear plate 215 may provide a decorative effect in the appearance of the electronic device 101. The first rear plate 215 may be manufactured using at least one of metal, glass, synthetic resin, or ceramic. According to an embodiment, the first rear plate 215 may be formed integrally with the first cover member 211.

According to an embodiment, the second housing part 202 may include a second cover member 221 (e.g., the second cover member 221 of FIGS. 2 and 3), a rear bracket 223, and a second rear plate 225.

According to an embodiment, the second cover member 221 may be connected to the first housing part 201 through the guide rail 250 and, while being guided by the guide rail 250, reciprocate linearly in one direction (e.g., the direction of arrow \textcircled{1} in FIG. 3).

According to an embodiment, the second cover member 221 may support at least a portion of the display 231. For example, the second cover member 221 may include a first surface F1. The first region A1 of the display 231 may be substantially positioned on the first surface F1 to maintain a flat panel shape. According to an embodiment, the second cover member 221 may be formed of a metal material and/or a non-metal (e.g., polymer) material. According to an embodiment, the first circuit board 248 accommodating the electronic component (e.g., the processor 120 and/or the memory 130 of FIG. 1) may be connected to the second cover member 221. According to an embodiment, the second cover member 221 may protect the components (e.g., the first circuit board 248 and the rear bracket 223) positioned in the second housing part 202 from external impact.

According to an embodiment, the rear bracket 223 may protect a component (e.g., the first circuit board 248) positioned on the second cover member 221. For example, the rear bracket 223 may be connected to the second cover member 221 and may be formed to surround at least a portion of the first circuit board 248. According to an embodiment, the rear bracket 223 may include an antenna (e.g., at least one antenna element 2231) for communicating with an external electronic device. For example, when the rear bracket 223 is formed of an injection molded product (e.g., an antenna carrier) of a dielectric material, the at least one antenna element 2231 may be disposed on an outer surface (e.g., one surface facing in the −Z-axis direction) of the rear bracket 223. For example, the at least one antenna element 2231 may include a laser direct structuring (LDS) antenna formed on the outer surface of the rear bracket 223. For example, the at least one antenna element 2231 may be formed to be embedded when the rear bracket 223 is injection-molded. For example, the at least one antenna element 2231 may be configured to transmit or receive wireless signals in a designated frequency band (e.g., a legacy band) by electrically connecting with a wireless communication circuit (e.g., the wireless communication module 192 of FIG. 1) disposed on the first circuit board 248.

According to an embodiment, the second rear plate 225 may substantially form at least a portion of the exterior of the second housing part 202 or the electronic device 101. For example, the second rear plate 225 may be coupled to the outer surface of the second cover member 221. According to an embodiment, the second rear plate 225 may provide a decorative effect on the exterior of the electronic device 101. The second rear plate 225 may be formed of at least one of metal, glass, synthetic resin, or ceramic. According to an embodiment, the second rear plate 225 may be integrally formed with the second cover member 221.

According to an embodiment, the display assembly 230 may include a display 231 (e.g., the display 231 of FIGS. 2 and/or 3) and a multi-bar structure 232 supporting the display 231. According to an embodiment, the display 231 may be referred to as a flexible display, a foldable display, and/or a rollable display. According to an embodiment, the first region A1 of the display 231 may be supported by a rigid body. The second region A2 may be supported by a bendable structure. For example, the first region A1 may be supported by the first surface F1 of the second cover member 221 or a plate (not shown). The second region A2 may be supported by the multi-bar structure 232.

According to an embodiment, the multi-bar structure 232 may be connected to or attached to at least a portion (e.g., the second region A2) of the display 231. According to an embodiment, as the second housing part 202 slides, the multi-bar structure 232 may move with respect to the first housing part 201. In a slide-in state of the electronic device 101 (e.g., FIG. 2), the multi-bar structure 232 may be mostly stored inside the first housing part 201. In a slide-in state of the electronic device 101 (e.g., FIG. 2), the multi-bar structure 232 may be positioned between the first cover member 211 and the second cover member 221. According to an embodiment, at least a portion of the multi-bar structure 232 may move corresponding to a curved surface 213a positioned at an edge of the frame 213. According to an embodiment, the multi-bar structure 232 may be referred to as a display supporting member or a support structure. The multi-bar structure 232 may include a plurality of bars. According to an embodiment, one of the plurality of bars included in the multi-bar structure 232 may have a thin and long form. According to an embodiment, a plurality of unit bars formed short in a width direction and long in a lengthwise direction may be assembled side by side in the lengthwise direction to form the multi-bar structure 232.

According to an embodiment, a driving module 240 may relatively move the second housing part 202 relative to the first housing part 201. For example, the driving module 240 may include an actuator 241 configured to generate driving force for sliding movement of the second housing part 202 with respect to the first housing part 201. The driving module 240 may include a gear 244 (e.g., pinion) connected to the actuator 241 and a rack 242 configured to mesh with the gear. Referring to FIG. 4, components of the driving module 240 (e.g., actuator 241, rack 242, and gear 244) inverted (e.g., facing the −Z-axis direction) are illustrated in circle P1.

According to an embodiment, the housing in which the rack 242 is positioned and the housing in which the actuator 241 is positioned may be different. According to an embodiment, the actuator 241 may be connected to the first housing part 201, and the rack 242 may be connected to the second housing part 202. According to an embodiment, the actuator 241 may be connected to the second housing part 202, and the rack 242 may be connected to the first housing part 201.

According to an embodiment, the actuator 241 may be controlled by a processor (e.g., the processor 120 of FIG. 1). For example, the processor 120 may include an actuator driver driving circuit and transfer a pulse width modulation (PWM) signal for controlling the speed of the actuator 241 and/or the torque of the actuator 241 to the actuator 241. According to an embodiment, the actuator 241 may be electrically coupled to a processor (e.g., the processor 120 of FIG. 1) positioned on the circuit board (e.g., the first circuit board 248 of FIG. 4) using a flexible printed circuit board.

According to an embodiment, the second housing part 202 may receive the first circuit board 248 (e.g., a main circuit board). According to an embodiment, the processor, memory, and/or interface may be mounted on the first circuit board 248. The processor may include one or more of, e.g., a central processing unit, an application processor, a graphic processing device, an image signal processing, a sensor hub processor, or a communication processor. According to various embodiments, the first circuit board 248 may include a flexible printed circuit board type radio frequency cable (FRC). The first circuit board 248 may be disposed on at least a portion of the second cover member 221 and may be electrically connected with an antenna module (e.g., the antenna module 197 of FIG. 1) and a communication module (e.g., the communication module 190 of FIG. 1). According to an embodiment, the first circuit board 248 may include an antenna (e.g., at least one antenna element 2481) for communicating with an external electronic device. An antenna (e.g., at least one antenna element 2481) disposed on the first circuit board 248 may be disposed additionally or alternatively to an antenna (e.g., at least one antenna element 2231) disposed on the rear bracket 223.

According to an embodiment, the memory may include, e.g., a volatile or non-volatile memory.

According to an embodiment, the interface may include, e.g., a high definition multimedia interface (HDMI), a universal serial bus (USB) interface, a secure digital (SD) card interface, and/or an audio interface. The interface may electrically or physically connect, e.g., the electronic device 101 with an external electronic device and may include a USB connector, an SD card/multimedia card (MMC) connector, or an audio connector.

According to an embodiment, the electronic device 101 may include a second circuit board 249 (e.g., a main circuit board) spaced apart from the first circuit board 248 (e.g., a sub circuit board) in the first housing part 201. The first circuit board 248 may be electrically connected to the second circuit board 249 through a flexible board. The first circuit board 248 may be electrically connected with electric components disposed in an end area of the electronic device 101, such as the battery 289 or a speaker and/or a sim socket, and may transfer signals and power. According to an embodiment, the first circuit board 248 may receive the antenna 2481 (e.g., a coil) or connect with the antenna 2481. The antenna 2481 may include a wireless charging antenna for a wireless charging function, a near field communication (NFC) antenna for an NFC first, and/or a multi-function coil (MFC) antenna including a magnetic secure transmission (MST) antenna for performing an electronic payment first. For example, the battery 289 may receive power from an external electronic device using the antenna 2481 for wireless charging. According to an embodiment, the battery 289 may transfer power to the external electronic device using the antenna 2481 for wireless charging. For example, the electronic device may also perform NFC functions and/or MST functions such as ticketing and contactless payment with external electronic devices using the antenna 2481.

According to an embodiment, the battery 289 may be a device for supplying power to at least one component of the electronic device 101. The battery 189 may include a primary cell which is not rechargeable, a secondary cell which is rechargeable, or a fuel cell. The battery 289 may be integrally or detachably disposed inside the electronic device 101. According to an embodiment, the battery 289 may be formed of a single embedded battery or may include a plurality of removable batteries. According to various embodiments, the battery 289 may be position on the frame 213. For example, the battery 289 may be surrounded by the frame 213 and the battery cover 289a. According to an embodiment, it may be positioned within the second housing part 202 and is slidable along with the second housing part 202.

According to an embodiment, the guide rail 250 may guide the movement of the multi-bar structure 232. The guide rail 250 may include a first guide rail 250A and a second guide rail 250B. The first guide rail 250A may be disposed between the frame 213 and a 1-2th side wall (e.g., the 1-2th side wall 211b of FIGS. 2 and 3) of the first housing part 201. The second guide rail 250B may be disposed between the frame 213 and a 1-3th side wall (e.g., the 1-3th side wall 211c of FIGS. 2 and 3) of the first housing part 201. A configuration of the second guide rail 250B may be identical in whole or part to a configuration of the first guide rail 250A. The multi-bar structure 232 may slide along a guide recess 251 formed in the guide rail 250. According to an embodiment, the guide rail 250 may be connected to the first housing part 201. For example, the guide rail 250 may be connected to the first cover member 211 and/or the frame 213. According to an embodiment, the guide recess 251 may be referred to as a groove or guide slit formed in an inner surface of the guide rail 250. FIG. 4 illustrates an enlarged guide rail 250 in the circle P2.

According to an embodiment, the guide rail 250 may provide driving force to move the multi-bar structure 232 based on driving of the actuator 241.

According to an embodiment, when the electronic device 101 changes from a slide-in state to a slide-out state, at least a portion of the second housing part 202 may slide to be visually exposed to the outside from the first housing part 201 through driving of the actuator 241. For example, the gear 244 may rotate in a first rotation direction based on the driving of the actuator 241. As the rack 242 is fixed on the second cover member 221 of the second housing part 202, the second housing part 202 may slide to be visually exposed to the outside of the first housing part 201 based on sliding movement of the rack 242 toward a slide-out direction.

According to an embodiment, when the electronic device 101 changes from a slide-in state to a slide-out state, the guide rail 250 may be configured to guide movement of the multi-bar structure 232. For example, the multi-bar structure 232 may move along the guide recess 251 of the guide rail 250. For example, at least a portion of the multi-bar structure 232 may change position on the guide recess 251 formed between an inner portion 252 and an outer portion 253. The second housing part 202 may slide to extend with respect to the first housing part 201. At least a portion of the display assembly 230 that was received between the first cover member 211 and the frame 213 may extend to the front.

According to an embodiment, when the electronic device 101 changes from the slide-out state to the slide-in state, at least a portion of the second housing part 202 may slide to be inserted into the first housing part 201 through driving of the actuator 241. For example, the gear 244 may rotate in a second rotation direction opposite to the first rotation direction based on the driving of the actuator 241. As the rack 242 is fixed on the second cover member 221 of the second housing part 202, the second housing part 202 may slide to enter the first housing part 201 based on the sliding movement of the rack 242 toward the slide-in direction.

According to an embodiment, when the electronic device 101 changes from the slide-out state to the slide-in state, the outer portion 253 of the guide rail 250 may provide a force to the bent multi-bar structure 232. The multi-bar structure 232 provided with the force may move along the guide recess 251 of the guide rail 250, and at least a portion of the second housing part 202 may slide to be accommodated in the first housing part 201. At least a portion of the display assembly 230 may be accommodated between the first cover member 211 and the frame 213.

According to an embodiment, the electronic device 101 may be configured to stop in a designated intermediate state between the slide-in state and the slide-out state by controlling driving of the actuator 241 (free stop function). According to an embodiment, the electronic device 101 may be changed to the slide-in state, the intermediate state, or the slide-out state through the user's manipulation in the state in which the driving force is not provided to the actuator 241.

Referring to FIG. 5A, in the slide-in state of the electronic device 101, at least a portion of the second housing part 202 may be disposed to be accommodated in the first housing part 201. As the second housing part 202 is disposed to be accommodated in the first housing part 201, the overall size of the electronic device 101 may be reduced. According to an embodiment, when the second housing part 202 is received in the first housing part 201, the size of the display 231 visually exposed may be minimized. For example, when the second housing part 202 is fully accommodated in the first housing part 201, the first region A1 of the display 231 may be visually exposed, and at least a portion (e.g., a portion facing in the −Z axis) of the second region A2 may be disposed between the battery 289 and the first rear plate 215.

Referring to FIG. 5B, in the slide-out state of the electronic device 101, at least a portion of the second housing part 202 may protrude from the first housing part 201. As the second housing part 202 protrudes from the first housing part 201, the overall size of the electronic device 101 may increase. According to an embodiment, when the second housing part 202 protrudes from the first housing part 201, at least a portion of the second region A2 of the display 231 may be visually exposed to the outside of the electronic device 101 together with the first region A1.

According to an embodiment, one end portion 2311 of the display 231 may be disposed between the first cover member 211 and a battery 289. The other end portion 2312 of the display 231 may be exposed to the outside while being fixed to the second cover member 221.

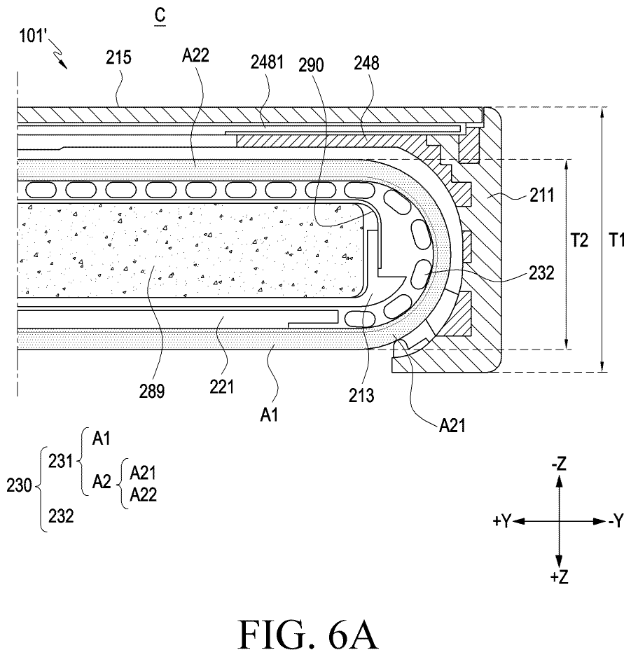

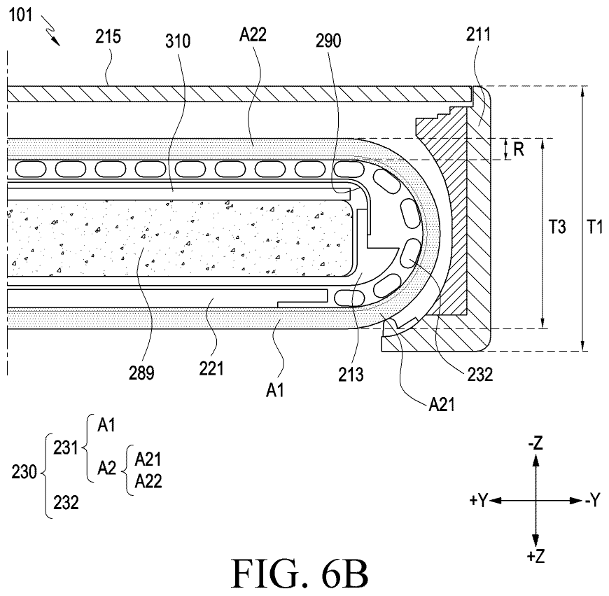

FIG. 6A is an enlarged view illustrating a portion of an electronic device according to an embodiment of the disclosure.

FIG. 6B is an enlarged view illustrating a portion of an electronic device according to an embodiment of the disclosure. Both FIGS. 6A and 6B may show enlarged views illustrating portion C in the electronic device in a slide-in state illustrated in FIG. 5A.

Referring to FIG. 6A, an electronic device 101′ according to a comparative embodiment may have an antenna (e.g., at least one antenna element 2481) for communicating with external electronic devices disposed between a rear plate 215 and a display 231. On the other hand, referring to FIG. 6B, an electronic device 101 according to an embodiment of the disclosure may have an antenna (e.g., at least one antenna element 310) for communicating with external electronic devices disposed inside a display assembly 230 including the display 231 and a multi-bar structure 232.

The electronic device 101′ of FIG. 6A and the electronic device 101 of FIG. 6B both show that the overall thickness of the device is the same T1. And, a partial thickness of the electronic device between a surface where one end portion (e.g., the one end portion 2311 of FIGS. 5A and 5B) of the display 231 is disposed and a surface where the other end portion (e.g., the other end portion 2312 of FIGS. 5A and 5B) is disposed in the electronic device 101′ of FIG. 6A is T2, and a partial thickness of the electronic device between a surface where one end portion (e.g., the one end portion 2311 of FIGS. 5A and 5B) of the display 231 is disposed and a surface where the other end portion (e.g., the other end portion 2312 of FIGS. 5A and 5B) is disposed in the electronic device 101 of FIG. 6B is T3, and the thickness T3 may be illustrated to be thicker than the thickness T2 by an interval R.

Referring to FIG. 6A, since an antenna (e.g., 2481) is disposed between the rear plate 215 and the display 231 of the electronic device 101′, space for the thickness of the antenna (e.g., 2481) and the thickness of a circuit board (e.g., the first circuit board 248) for disposing the antenna (e.g., 2481) may be required between the rear plate 215 and the display 231. In contrast, the electronic device 101 illustrated in FIG. 6B does not need to have an antenna and a circuit board for disposing it between the rear plate 215 and the display 231, so the curvature of the display 231 may be made smaller by that space (the radius of curvature may be made larger), and accordingly, the repulsive force of the display 231 may be decreased. Referring to FIG. 6A, since an antenna (e.g., 2481) is disposed between the rear plate 215 and the display 231 of the electronic device 101′, space for the thickness of the antenna (e.g., 2481) and the thickness of a circuit board (e.g., the first circuit board 248) for disposing the antenna (e.g., 2481) may be required. In contrast, the electronic device 101 illustrated in FIG. 6B does not need to have an antenna and a circuit board for disposing it between the rear plate 215 and the display 231, so the curvature of the display 231 may be made smaller by that space (the radius of curvature may be made larger), and accordingly, the repulsive force of the display 231 may be made smaller.

The electronic device of the disclosure may be configured such that when the electronic device 101 is in a slide-in state, an antenna 310 is disposed between a second region A2 of the display 231 and a first region A1 of the display 231 to make the curvature of the display smaller (and/or to reduce display repulsive force). The electronic device of the disclosure may also be understood as at least a portion of the second region A2 being disposed between the rear plate 215 and the antenna 310. The electronic device of the disclosure may also be understood as the antenna 310 being disposed inside the display assembly 230.

Referring to FIGS. 6A and 6B, the display 231 may include, in a slide-in state of the electronic device 101, a first region A1 corresponding to a screen display area and a second region A2 stored inside the electronic device 101. The second region A2 may include, in a slide-in state of the electronic device 101, a 2-1th area A21 connected to the first region A1 and partially bent corresponding to a curved surface (the curved surface 213a of FIG. 4), and a 2-2th area A22 connected to the 2-1th area A21 and disposed on a different plane from the first region A1. In the disclosure, “when the electronic device 101 is in a slide-in state, an antenna 310 is configured to be disposed between a second region A2 of the display 231 and a first region A1 of the display 231” may mean “when the electronic device 101 is in a slide-in state, the antenna 310 is disposed between a 2-2th area A2 of the display 231 and a first region A1 of the display 231.”

According to an embodiment, a protective layer 290 may be disposed between the display 231 and the antenna 310. The protective layer 290 may be provided to prevent physical and chemical impacts on the antenna 310. According to an embodiment, the protective layer 290 may include a material that minimizes effects on signals transmitted from or received by the antenna 310, e.g., a non-conductive material.

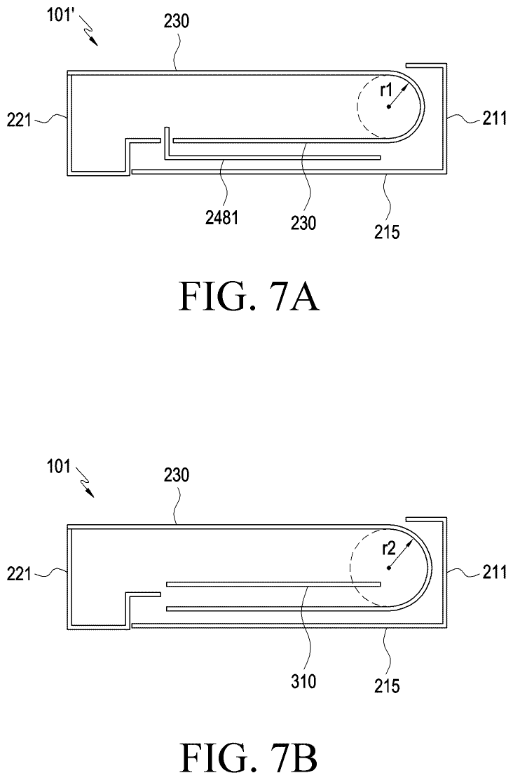

FIG. 7A is an enlarged view illustrating a portion of an electronic device according to an embodiment of the disclosure. FIG. 7B is an enlarged view illustrating a portion of an electronic device according to an embodiment of the disclosure.

FIG. 7A conceptually illustrates the embodiment of FIG. 6A, and FIG. 7B may conceptually show the embodiment of FIG. 6B. Both FIGS. 7A and 7B may briefly show relative positions of an antenna with respect to the rear plate 215 and the display assembly 230.

Referring to FIG. 7A, an electronic device 101′ according to a comparative embodiment has an antenna (e.g., 2481) disposed between the rear plate 215 and the display assembly 230, and in this case, a radius of curvature of a display included in the display assembly 230 may be r1. Referring to FIG. 7B, an electronic device 101 according to an embodiment has an antenna (e.g., 310) disposed inside the display assembly 230, and in this case, a radius of curvature of a display included in the display assembly 230 may be r2. As described above in the embodiments of FIGS. 6A and 6B, the embodiment of FIG. 7B has fewer spatial constraints for disposing the display assembly 230 compared to the embodiment of FIG. 7A, so the radius of curvature of the display may be formed to be larger. For example, the radius of curvature r1 of FIG. 7A may be formed as 3.5 (mm), and the radius of curvature r2 of FIG. 7B may be formed as 4 (mm). However, this is merely an example, and the numerical range may vary according to embodiments.

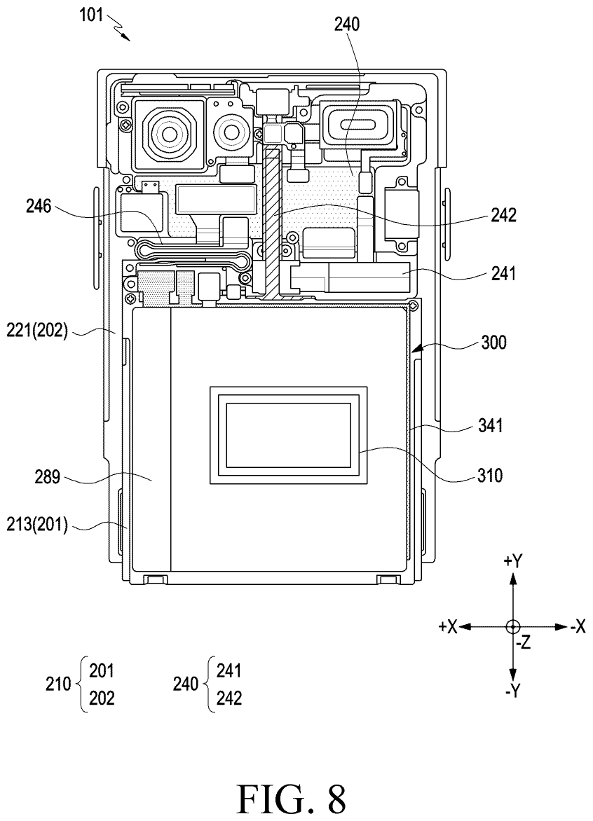

FIG. 8 is a view illustrating an inside of an electronic device according to an embodiment of the disclosure.

FIG. 8 may show an internal view in a slide-in state of the electronic device. In describing the embodiment of FIG. 8, descriptions in overlapping ranges with components mentioned in the embodiments of FIGS. 1 to 4, 5A, 5B, 6A, 6B, 7A, and 7B may be omitted.

According to an embodiment, the electronic device 101 may include a housing 210 including a first housing part 201 and a second housing part 202 configured to move in a first direction or a second direction (e.g., \textcircled{1} direction of FIG. 3) opposite to the first direction with respect to the first housing part 201. The electronic device 101 may include a flexible display (e.g., the display 231 of FIGS. 2 to 4, 5A, 5B, 6A, 6B, 7A, and 7B) configured to move based on movement of the second housing part 202. The electronic device 101 may include a multi-bar structure (e.g., the multi-bar structure 232 of FIGS. 4, 5A, 5B, 6A, and 6B) configured to support at least a portion of the flexible display 231 and including a plurality of bars. In FIG. 8, a frame 213 except for a first cover member (e.g., the first cover member 211 of FIG. 4) is illustrated as the first housing part 201, and a second cover member 221 is illustrated as the second housing part 202.

The electronic device 101 may include a circuit board (e.g., the first circuit board 248 of FIG. 4 or the second circuit board 249 of FIG. 4) on which at least one processor (e.g., the processor 120 of FIG. 1) and memory (e.g., the memory 130 of FIG. 1) are disposed. Referring to FIG. 8, the electronic device 101 may further include a circuit board 246 different from a circuit board (e.g., the first circuit board 248 of FIG. 4 or the second circuit board 249 of FIG. 4) on which the at least one processor (e.g., the processor 120 of FIG. 1) and the memory (e.g., the memory 130 of FIG. 1) are disposed. The circuit board 246 may hereinafter be referred to as a third circuit board 246. According to an embodiment, the third circuit board 246 may be provided for electrical connection between a circuit board(s) (e.g., the first circuit board 248 of FIG. 4 or the second circuit board 249 of FIG. 4) and/or other electronic components. According to the embodiment illustrated in FIG. 4, the third circuit board 246 may be provided for electrical connection between the first circuit board 248 and the second circuit board 249 and/or electrical connection between the second circuit board 249 and other electronic components (e.g., battery 289). According to an embodiment, the third circuit board 246 may include a flexible printed circuit board type (FPCB type) radio frequency cable (FRC). The third circuit board 246 may be configured to fold as illustrated in FIG. 8 when the electronic device is in a slide-in state, and to unfold when the electronic device is in a slide-out state. Accordingly, using the third circuit board 246, stable transmission of signals and/or power may be possible even when the electronic device 101 repeatedly transitions between slide-in and slide-out states multiple times.

The electronic device 101 may further include a circuit board 300 provided additionally or alternatively to the first circuit board 248, the second circuit board 249, and/or the third circuit board 246. The circuit board 300 may hereinafter be referred to as a fourth circuit board 300. According to an embodiment, the fourth circuit board 300 may be provided for electrical connection between a circuit board(s) (e.g., the first circuit board 248 of FIG. 4, the second circuit board 249 of FIG. 4, and/or the third circuit board 246) and/or other electronic components. However, without limitations thereto, according to an embodiment, the fourth circuit board 300 may also be provided to dissipate heat generated from a circuit board(s) (e.g., the first circuit board 248 of FIG. 4, the second circuit board 249 of FIG. 4, and/or the third circuit board 246) and/or other electronic components to a relatively low-temperature area (e.g., an area where the battery 289 is disposed). According to an embodiment, the fourth circuit board 300 may be integrated with at least one circuit board among the first circuit board 248, the second circuit board 249, and/or the third circuit board 246. According to an embodiment, the fourth circuit board 300 may be disposed at a position adjacent to the battery 289. According to an embodiment, the fourth circuit board 300 may be disposed between the battery 289 and the rear plate 215. According to an embodiment, the fourth circuit board 300 may be configured to face one surface of the battery 289. According to an embodiment, the fourth circuit board 300 may be formed with a thin thickness and may have a wide flat plate form to cover most of the area of one surface of the battery 289. According to an embodiment, the fourth circuit board 300 may include a printed circuit board (PCB), a flexible printed circuit board (FPCB), and/or a flexible printed circuit board type (FPCB type) radio frequency cable (FRC).

The electronic device 101 may include an antenna (e.g., at least one antenna element) 310 electrically connected to a circuit board (e.g., the first circuit board 248, the second circuit board 249, the third circuit board 246, and/or the fourth circuit board 300). According to an embodiment, the antenna 310 of the electronic device 101 may be provided additionally or alternatively to the antenna 2481 of FIG. 4. According to an embodiment, the antenna 310 may be disposed on one surface of the circuit board 300 disposed between the battery 289 and the rear plate 215. For example, an antenna pattern 310 may include a coil having at least one turn number. According to an embodiment, the antenna 310 may be an antenna 310 having an operating frequency in a low frequency band. For example, the antenna 310 may include a wireless charging antenna for a wireless charging function, an NFC antenna for NFC function, and/or an MST antenna for performing electronic payment function. The antenna 310 may include a multi-function coil (MFC) antenna that performs two or more functions among the wireless charging antenna, the NFC antenna, or the MST antenna.

Referring to FIG. 8, the electronic device 101 may include a driving module 240 including an actuator 241 and a rack 242. According to an embodiment of the disclosure, an electronic device 101 that may reduce repulsive force of a display (e.g., the display 231 of FIGS. 2 to 4, 5A, 5B, 6A, 6B, 7A, and 7B) by increasing a radius of curvature of the display without increasing a size of the actuator 241 and/or increasing output may be provided. To this end, the electronic device 101 may dispose the antenna 310 inside the display 231. In other words, the disclosure may provide embodiments of an electronic device 101 in which the display 231 is disposed between the housing 210 and the antenna 310.

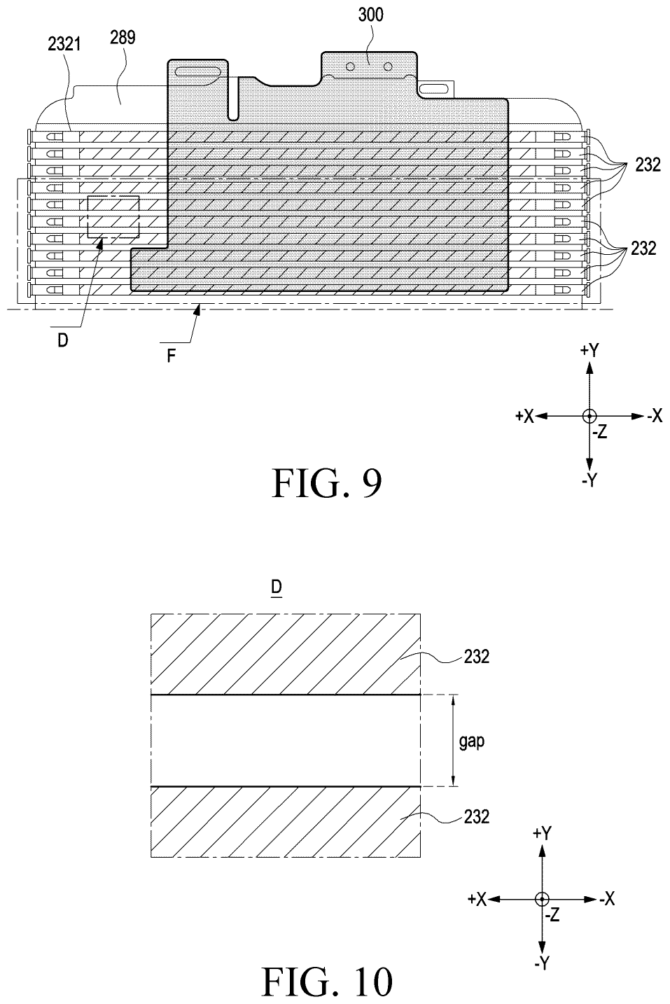

FIG. 9 is a view illustrating an arrangement relationship of a battery, a circuit board, and a multi-bar structure according to an embodiment of the disclosure.

FIG. 10 is a view illustrating a gap between two adjacent bars among a plurality of bars included in a multi-bar structure according to an embodiment of the disclosure. FIG. 10 may be an enlarged view of portion D in the embodiment of FIG. 9.

The embodiment of FIG. 9 may show the battery 289 and circuit board 300 portions in more detail in the electronic device 101 illustrated in the embodiment of FIG. 8. Further, the embodiment of FIG. 9 additionally illustrates the multi-bar structure 232 compared to the embodiment of FIG. 8.

Referring to FIG. 9, when viewing the electronic device 101 from above (e.g., when viewing from the +Z-axis direction to the −Z-axis direction), according to an embodiment, the circuit board 300 may overlap most of the area of the battery 289. Although not illustrated in the drawings, the electronic device 101 may further include a heat dissipation member including a heat dissipation material (e.g., graphite) on a surface facing the battery 289. By further including a heat dissipation member including a heat dissipation material (e.g., graphite) on a surface of the circuit board 300 facing the battery 289, heat discharged from heat-generating components (e.g., the processor) included in the electronic device 101 may be dissipated to a relatively low-temperature area (e.g., battery 289 side area).

Referring to FIGS. 9 and 10, when viewing the electronic device 101 from above (e.g., when viewing from the +Z-axis direction to the −Z-axis direction), according to an embodiment, the electronic device 101 may include a multi-bar structure 232 disposed to overlap most of the area of the circuit board 300 in a slide-in state of the electronic device 101. The multi-bar structure 232 includes a plurality of bars, and the plurality of bars may be spaced apart from each other by a predetermined interval. According to an embodiment, distances by which the plurality of bars are spaced apart may be constant. For example, two adjacent bars among the plurality of bars may be spaced apart by a predetermined gap, and this predetermined gap may be maintained substantially constant at intervals between other plurality of bars.

According to an embodiment, the multi-bar structure 232 may be configured to support at least a portion of the second region A2 of the display 231 (e.g., the 2-1th area A21 of FIGS. 6A and 6B). According to an embodiment, the multi-bar structure 232 may include a conductive material (e.g., metallic material or non-metallic but conductive material).

According to an embodiment, the distance between the plurality of bars may be referred to as a ‘gap’. However, it is not necessarily limited thereto, and may also be referred to by other various terms such as hole or opening.

According to an embodiment, the multi-bar structure 232 may include a plurality of bars, and a plurality of gaps may be defined between two adjacent bars among the plurality of bars.

In the disclosure, by disposing the antenna 310 between the first region A1 and the second region A2 of the display 231 in a slide-in state of the electronic device 101, there may be provided embodiments that may enhance antenna performance as an antenna 310 capable of communicating with external electronic devices while reducing repulsive force of the display by forming a small curvature of the display.

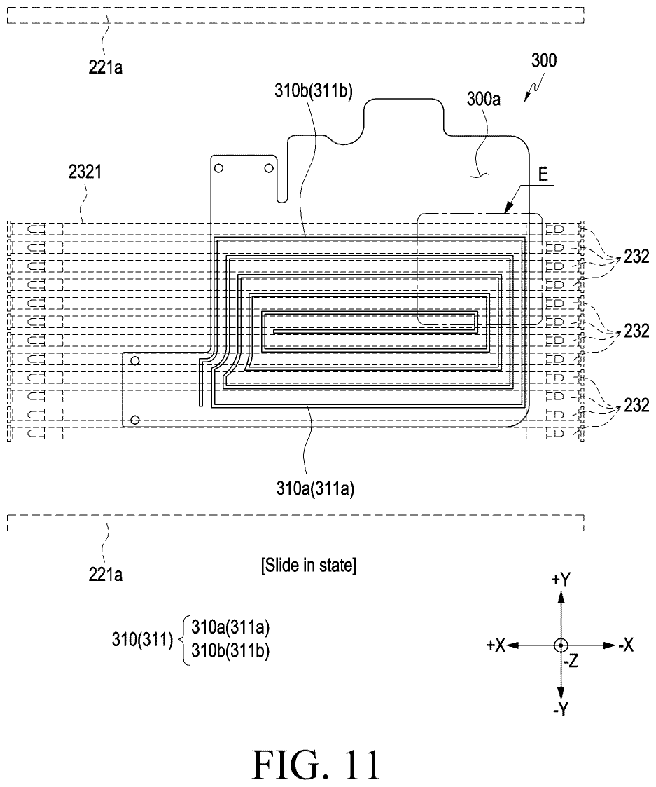

FIG. 11 is a view illustrating an arrangement relationship of a circuit board, a multi-bar structure, and an antenna according to an embodiment of the disclosure.

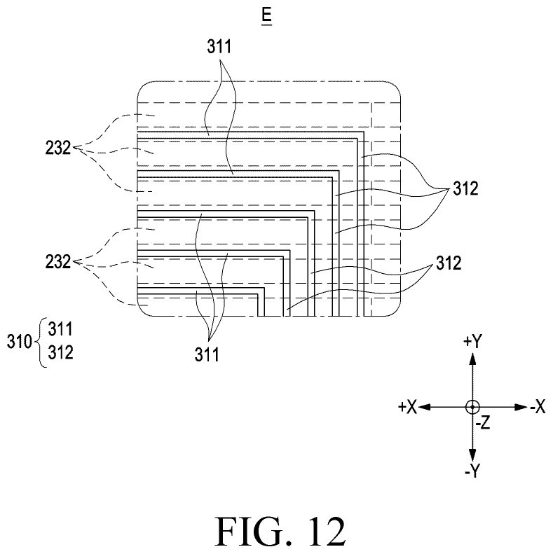

FIG. 12 is a view illustrating a plurality of first patterns of an antenna disposed at positions corresponding to gaps between two adjacent bars among a plurality of bars included in a multi-bar structure according to an embodiment of the disclosure. FIG. 12 may be an enlarged view of portion E in the embodiment of FIG. 11.

Referring to FIG. 11, an antenna 310 may be disposed on one surface 300a of the circuit board 300. The antenna 310 may include a coil having a plurality of turns. According to an embodiment, the antenna 310 may cover a wide area of one surface 300a of the circuit board 300. According to an embodiment, the antenna 310 may have a rectangular shape overall. However, specific shapes or areas may differ in each embodiment. For example, as illustrated in FIG. 11, except for some areas (left side) of the antenna 310, the remaining areas may have a rectangular shape overall. According to an embodiment, when the antenna 310 is disposed between a first point 310a (e.g., a first point 311a of a plurality of first patterns 311) on one surface 300a of the circuit board 300 and a second point 310b (e.g., a second point 311b of the plurality of first patterns 311) farther than the first point 310a with respect to a 1-1th side wall 211a of a first cover member 211 (e.g., the first cover member 211 of FIG. 3), in a slide-in state of the electronic device 101, a position (e.g., initial position or reference position) of one end portion 2321 of the multi-bar structure may be disposed at a position farther than the first point 310a with respect to a movement direction of the display (e.g., the display 231 of FIGS. 2 to 4, 5A, 5B, 6A, and 6B) (e.g., first direction (−Y-axis direction in FIG. 11)). According to an embodiment, as illustrated in FIG. 11, when the antenna 310 is disposed between a first point 310a on one surface 300a of the circuit board 300 and a second point 310b farther than the first point 310a with respect to the 1-1th side wall 211a, a position (e.g., initial position or reference position) of one end portion 2321 of the multi-bar structure may be disposed at a position farther than the second point 310b with respect to a movement direction of the display (e.g., the display 231 of FIGS. 2 to 4, 5A, 5B, 6A, and 6B) (e.g., first direction (−Y-axis direction in FIG. 11)) in a slide-in state of the electronic device 101. According to an embodiment, based on movement of a second housing part (e.g., the second housing part 202 of FIGS. 2 to 4, 5A, 5B, 6A, and 6B), when a display (e.g., the display 231 of FIGS. 2 to 4, 5A, 5B, 6A, and 6B) moves, the antenna 310 may be configured such that an area overlapping an area where the multi-bar structure 232 is disposed decreases.

Referring to FIG. 12, the antenna 310 may include a plurality of first patterns 311 extending in one direction. According to an embodiment, the plurality of first patterns 311 may also be referred to as “a plurality of first coils” or “a plurality of first conductive lines.” According to an embodiment, the plurality of first patterns 311 may be arranged parallel to one lengthwise direction of the plurality of bars. The plurality of first patterns 311 may provide a structure in which the plurality of first patterns 311 may be disposed between a plurality of bars that are parallel to each other and spaced apart from each other by a constant distance in the disclosure. When the electronic device 101 is in a slide-in state, the plurality of bars and the plurality of first patterns are alternately disposed along a first direction perpendicular to the first direction (or lengthwise direction of bars).

According to an embodiment, when the electronic device is in a slide-in state, the center of each of the plurality of first patterns 311 may be positioned in an area corresponding to the center of each of a plurality of gaps.

According to an embodiment, an antenna pattern 310 may include a plurality of second patterns 312 extending from the plurality of first patterns 311. According to an embodiment, the plurality of second patterns 312 may also be referred to as “a plurality of second coils” or “a plurality of second conductive lines.” The plurality of second patterns 312 may form a loop together with the plurality of first patterns 311. Here, a loop may not only mean a completely closed loop. For example, as illustrated in FIG. 11, when the plurality of first patterns 311 and the plurality of second patterns 312 are connected, the coil may have a form wound multiple times around concentric circles. According to an embodiment, the plurality of second patterns 312 may extend along a first direction.

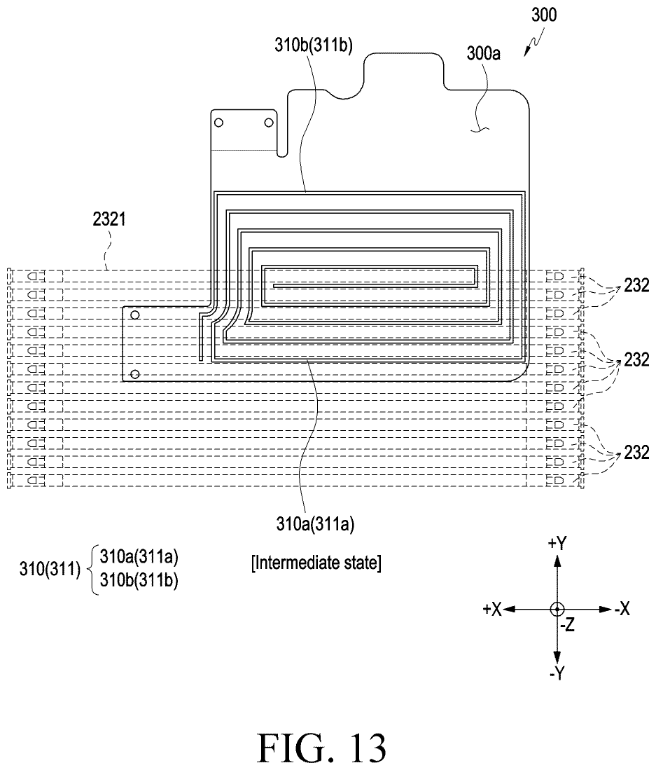

FIG. 13 is a view illustrating an arrangement relationship of a circuit board, a multi-bar structure, and an antenna according to an embodiment of the disclosure.

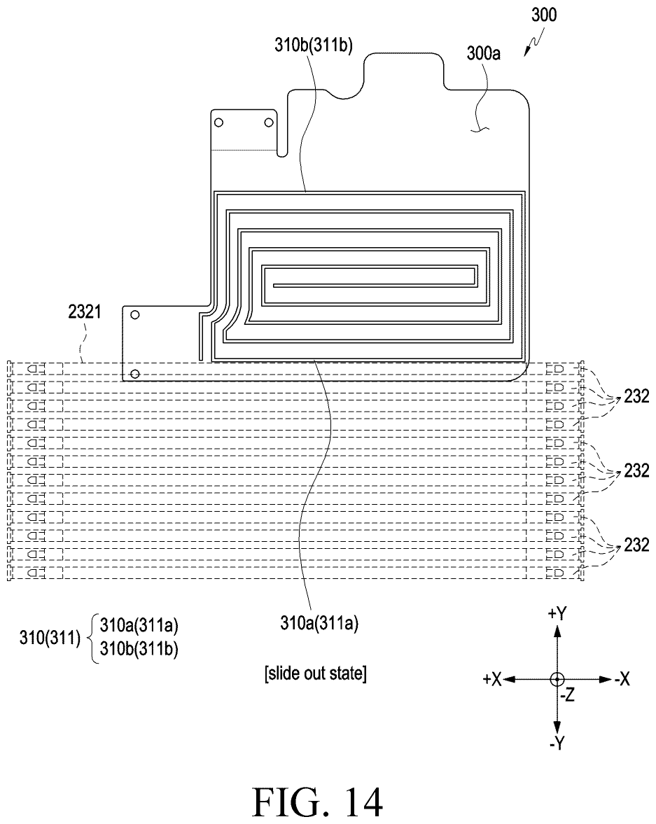

FIG. 14 is a view illustrating an arrangement relationship of a circuit board, a multi-bar structure, and an antenna according to an embodiment of the disclosure.

If FIG. 11 showed an arrangement relationship in a slide-in state of the electronic device, FIG. 14 illustrates an arrangement relationship in a slide-out state of the electronic device, and FIG. 13 may show an arrangement relationship in an intermediate state between FIGS. 11 and 14.

Referring to FIGS. 11 to 14, when the electronic device 101 is in a slide-in state, a fully retracted position of the second housing part 202 may be set such that one end portion 2321 of the multi-bar structure 232 is disposed between an outermost portion of the plurality of first patterns 311 and a 2-1th side wall 221a of the second housing part 202 (e.g., second cover member 221).

According to an embodiment, the multi-bar structure 232 is configured such that as the second housing part 202 moves in a second direction (e.g., +Y-axis direction) with respect to the first housing part 201, one end portion 2321 of the multi-bar structure 232 moves in a first direction (e.g., −Y-axis direction) opposite to the second direction (e.g., +Y-axis direction). Accordingly, an area where a plurality of gaps are aligned with at least one of corresponding plurality of first patterns 311 may substantially gradually decrease.

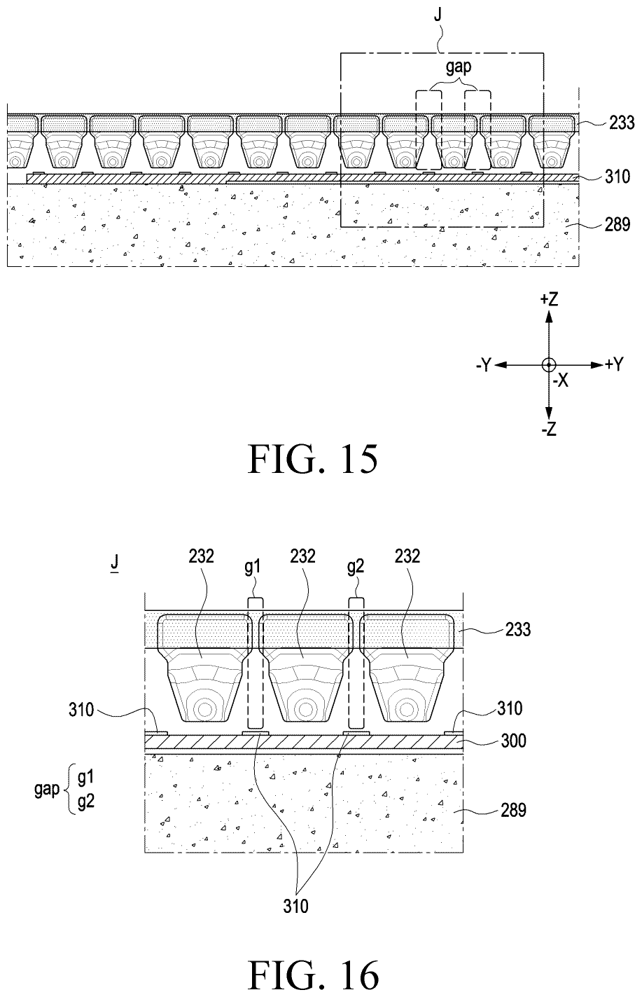

FIG. 15 is a view illustrating an arrangement relationship of a lattice structure, multi-bars, and an antenna pattern according to an embodiment of the disclosure.

FIG. 16 is an enlarged view illustrating a lattice structure, multi-bars, and an antenna pattern according to an embodiment of the disclosure.

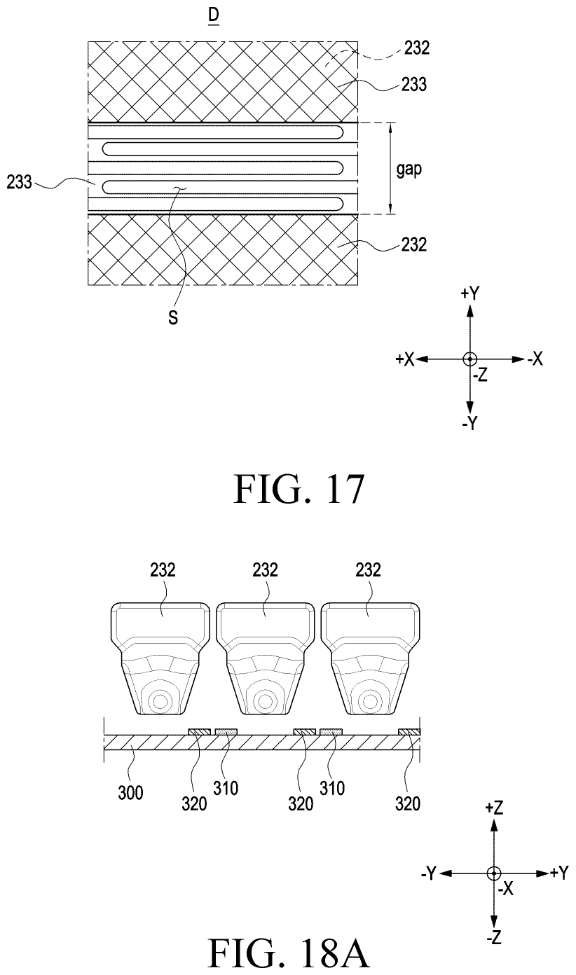

FIG. 17 is a view illustrating gaps between two adjacent bars among a plurality of bars included in a multi-bar structure and slits of a lattice structure disposed corresponding thereto according to an embodiment of the disclosure. FIG. 17 may be an enlarged view of portion D in a state in which a lattice structure is additionally disposed in the embodiment of FIG. 9.

The antenna 310 illustrated in FIGS. 15 and 16 may show a plurality of first patterns (e.g., the plurality of first patterns 311 of FIG. 12) included in the antenna 310.

According to an embodiment of the disclosure, gaps (e.g., g1, g2) defined between two adjacent bars among a plurality of bars of the multi-bar structure 232 may be configured to correspond to positions of at least a portion of the plurality of first patterns 311 in a state in which the size of the housing is minimum (or in a slide-in state of the electronic device). The multi-bar structure 232 may include a plurality of bars including conductive material and, when these metallic material bars and the antenna 310 are disposed at positions corresponding to each other when viewed from above (e.g., when looking from +Z axis to −Z axis), they may be coupled to each other, causing operating frequency to be tuned and thereby reducing antenna efficiency. In the disclosure, the electronic device 101 may achieve high antenna performance by disposing at least a portion of the antenna 310 at positions corresponding to gaps between two adjacent bars among a plurality of bars included in the multi-bar structure 232 in a slide-in state of the electronic device 101. Here, the antenna 310 disposed at positions corresponding to the gaps may correspond to the plurality of first patterns 311.

According to an embodiment, referring to FIGS. 11 to 16 together, the plurality of first patterns 311 of the antenna 310 may be disposed at positions corresponding to a plurality of gaps (e.g., g1, g2). When the plurality of first patterns 311 of the antenna 310 are disposed at positions corresponding to gaps in this way, the antenna 310 may perform communication with antennas of external electronic devices more smoothly through the gaps. According to an embodiment, as the antenna 310 is disposed at positions corresponding to gaps, e.g., coupling phenomena between conductive material-including multi-bar structures 232 may be decreased. For antennas 310 having operating frequencies in high frequency bands (e.g., 2 GHZ or higher), beamforming for wider areas may be possible through coupling with the multi-bar structure 232. However, unlike this, antennas 310 having operating frequencies in low frequency bands (e.g., less than 2 GHZ), for example NFC antennas/MST antennas/wireless charging antennas, may have antenna transmission/reception efficiency degraded by coupling between antenna patterns and multi-bar structures. In the disclosure, by disposing the antenna 310 at positions corresponding to gaps of the multi-bar structure 232, degradation of antenna transmission/reception efficiency due to coupling between the antenna 310 and the multi-bar structure 232 may be prevented. For example, the electronic device of the disclosure may dispose antenna patterns at positions corresponding to gaps when the electronic device is in a slide-in state. According to an embodiment, the antenna 310 is configured to be disposed at positions corresponding to gaps when the electronic device is in a fully slide-in state and, when the electronic device transitions to a slide-out state, by reducing an overlapping area between the antenna 310 and the multi-bar structure 232, antenna transmission/reception efficiency may be prevented from at least decreasing.

Referring to FIGS. 15 to 17, the electronic device 101 may further include a lattice structure 233 for supporting the display 231 between the multi-bar structure 232 and the display 231. The lattice structure 233 may be provided to increase support force for the display 231. According to an embodiment, the lattice structure 233 may also be formed of conductive material similar to a plurality of bars included in the multi-bar structure. According to an embodiment, slits S may be formed in the lattice structure 233 to support the display while reducing repulsive force. According to an embodiment, slits S may be formed in the lattice structure 233 at positions corresponding to gaps of the metal bar structure.

According to an embodiment, each of the plurality of first patterns 311 of the antenna 310 may be formed to be aligned with corresponding gaps among the plurality of gaps to radiate signals from the antenna 310 through gaps of the multi-bar structure 232 in a slide-in state of the electronic device 101, as well as additionally aligned with slits S of the lattice structure 233.

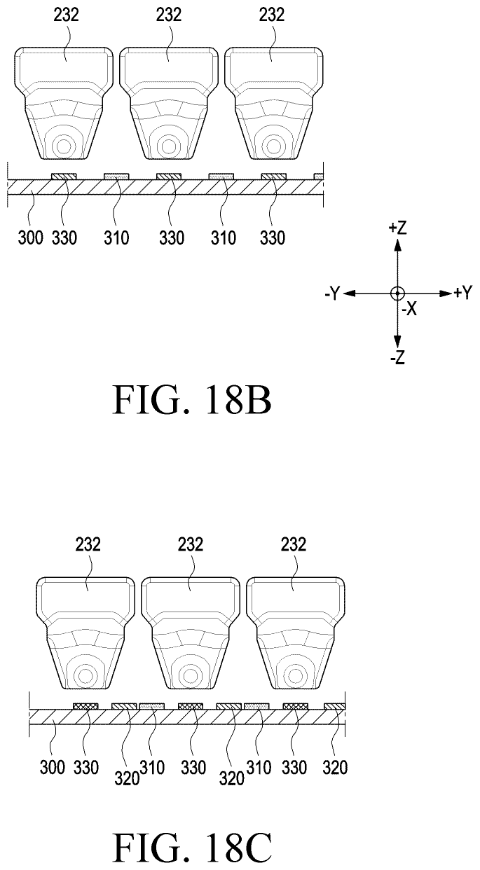

FIG. 18A is an enlarged view illustrating a multi-bar structure and an antenna according to an embodiment of the disclosure.

FIG. 18B is an enlarged view illustrating a multi-bar structure and an antenna according to an embodiment of the disclosure.

FIG. 18C is an enlarged view illustrating a multi-bar structure and an antenna according to an embodiment of the disclosure.

According to an embodiment, the antenna 310 may include a plurality of first patterns at positions corresponding to gaps (e.g., the gaps of FIGS. 15 to 17) between two adjacent bars among a plurality of bars included in the multi-bar structure 232 in a slide-in state of the electronic device 101. Referring to FIG. 18A, two antenna patterns 310, 320 are each illustrated at positions corresponding to gaps. The antenna patterns 310, 320 illustrated in FIG. 18A may all be a plurality of first patterns (e.g., 311) toward a lengthwise direction of bars (e.g., third direction).

Referring to FIGS. 18A to 18C, that a component (e.g., antenna) is disposed at a position corresponding to another component (e.g., slit) means, when viewing the electronic device from above (e.g., when looking from +Z-axis direction to −Z-axis direction), not only being disposed on a line virtually drawn from the other component (e.g., gap), but also being disposed such that at least a portion of the component (e.g., antenna) overlaps the virtually drawn line.

According to an embodiment, an antenna may include a first pattern disposed at a position corresponding to a gap (e.g., the gaps of FIGS. 15 to 17) between two adjacent bars among a plurality of bars included in the multi-bar structure 232 and a third pattern disposed at a position corresponding to one bar among the plurality of bars in a slide-in state of the electronic device 101. Referring to FIG. 18B, one antenna pattern 310 may be disposed at a position corresponding to a gap, and one antenna pattern 330 may be disposed at a position corresponding to a bar. The antenna patterns 310, 330 illustrated in FIG. 18B may be a first pattern (e.g., 311) parallel to a lengthwise direction of bars and configured to be disposed at a position corresponding to a gap, and a third pattern parallel to the first pattern. In a slide-in state of the electronic device, transmission/reception efficiency of the antenna 310 may be increased through a first pattern (e.g., 311) disposed at a position corresponding to a gap. For example, for antennas using low frequency bands such as NFC, MST, and/or wireless charging, antenna efficiency may be increased through a first pattern (e.g., 311) disposed at a position corresponding to a gap. In contrast, through a third pattern disposed at a position corresponding to a bar, e.g., when an antenna pattern 330 is used as an antenna for operating in high frequency bands, frequency bands may be extended (wide) through coupling with multi-bars. According to an embodiment, an effect of extending antenna bands may be achieved through a third pattern disposed at a position corresponding to a bar.

According to an embodiment, an antenna pattern may include a plurality of first patterns disposed at positions corresponding to gaps between two adjacent bars among a plurality of bars included in the multi-bar structure 232 and a third pattern disposed at a position corresponding to one bar among the plurality of bars in a slide-in state of the electronic device. Referring to FIG. 18C, a plurality of antenna patterns 310, 320 may be disposed at positions corresponding to slits, and one antenna pattern 330 may be disposed at a position corresponding to a bar.

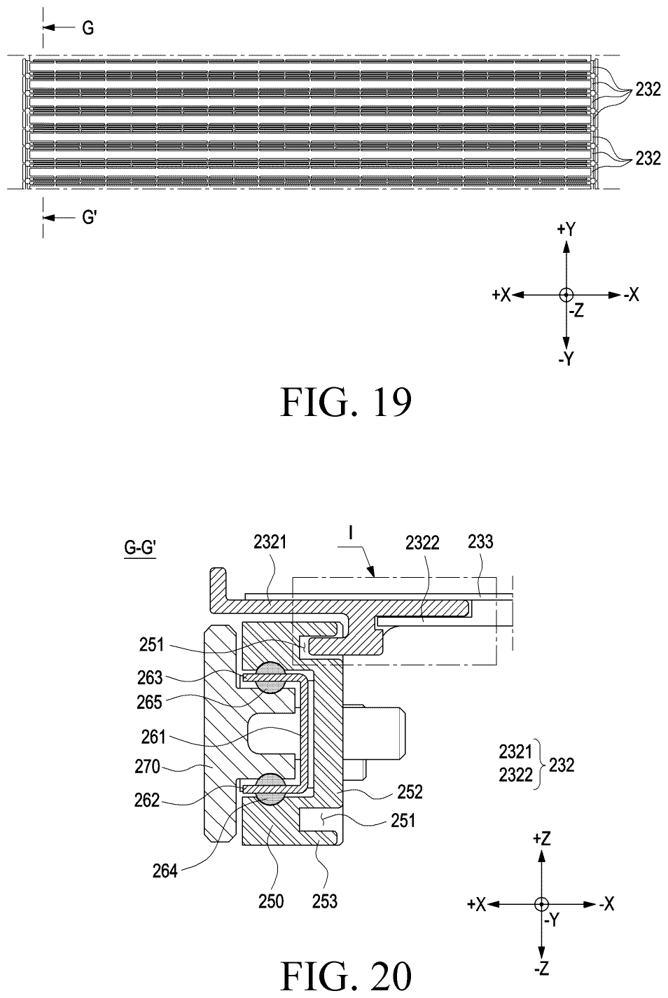

FIG. 19 is a view illustrating a view illustrating a multi-bar structure from above according to an embodiment of the disclosure.

FIG. 20 is a view illustrating an arrangement relationship of a multi-bar structure and a guide rail according to an embodiment of the disclosure.

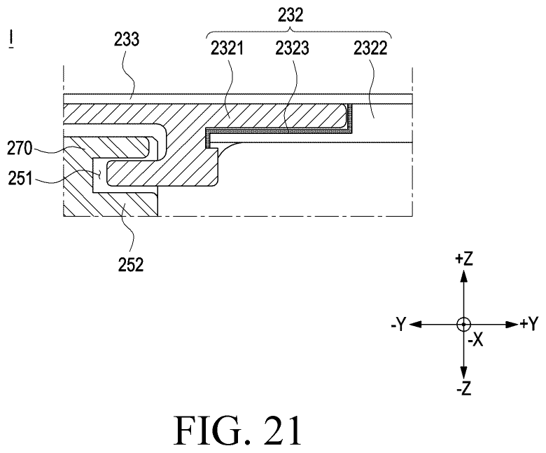

FIG. 21 is an enlarged view illustrating an arrangement relationship of a multi-bar structure and a guide rail according to an embodiment of the disclosure.

FIG. 20 may show a cross-section of FIG. 19 cut in the G-G′ direction, and FIG. 21 may be an enlarged view of portion I in the drawing of FIG. 20.

The guide rail 250 may guide movement of the multi-bar structure 232. As described above, the multi-bar structure 232 may move along a guide recess 251 of the guide rail 250. For example, at least a portion of the multi-bar structure 232 may change position on the guide recess 251 formed between an inner portion 252 and an outer portion 253. According to an embodiment, an inner portion 252 of the guide rail 250 may have a structure supported by approximately ‘U’-shaped middle guides 261, 262, 263 and guide balls 264, 265 disposed thereon illustrated in FIG. 16. Referring to FIG. 19, the middle guides 261, 262, 263 and guide balls 264, 265 may be supported by a bracket 270 (e.g., side member) on the other side. The configuration and/or arrangement relationship of the guide rail 250, middle guides 261, 262, 263, and bracket 270 illustrated in FIG. 19 is merely an example and does not limit the scope of rights of the disclosure. The configuration and/or arrangement relationship of the guide rail 250, middle guides 261, 262, 263, and bracket 270 may be configured differently from the embodiment illustrated in FIG. 19.

In the disclosure, a configuration for electrically insulating from a guide rail 250 supporting the multi-bar structure 232 may be disclosed so that the multi-bar structure 232 and/or lattice structure 233 composed of conductive material do not couple with the antenna 310.

According to an embodiment, as referenced in FIG. 20, the multi-bar structure 232 may be configured to include a multi-bar body 2322 and a multi-bar head 2321. According to an embodiment, the multi-bar body 2322 may be electrically insulated from the multi-bar head 2321. For example, as illustrated in FIG. 21, an insulating material 2323 (e.g., insulating tape or adhesive) may be disposed between the multi-bar body 2322 and the multi-bar head 2321.

According to an embodiment, although not illustrated in the drawings, an insulating material (e.g., insulating tape or adhesive) may also be disposed between the multi-bar structure 232 and the lattice structure 233.

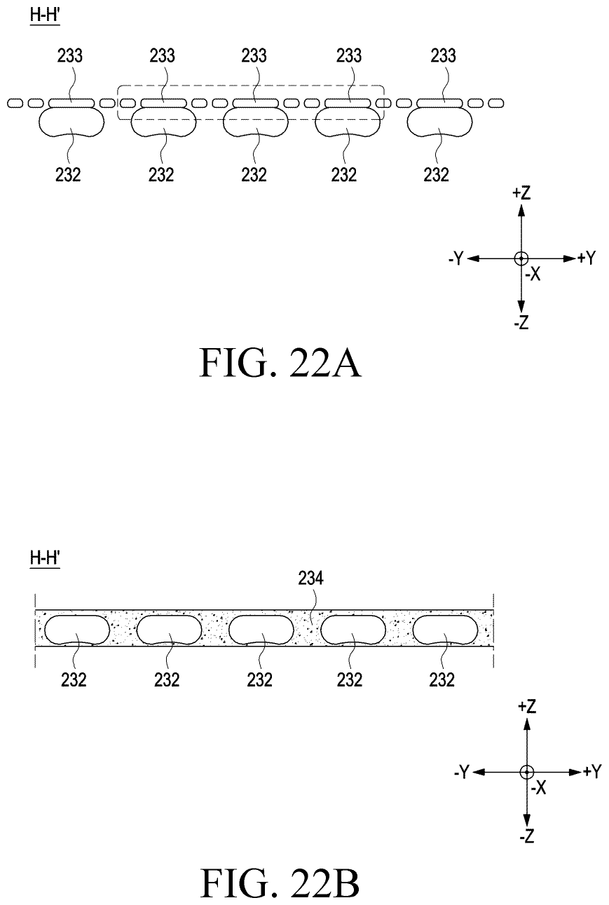

FIG. 22A is a cross-sectional view illustrating a multi-bar structure and a lattice structure according to an embodiment of the disclosure.

FIG. 22B is a cross-sectional view illustrating a multi-bar structure and a dielectric material according to an embodiment of the disclosure. FIGS. 22A and 22B may show a cross-section of FIG. 19 cut in the H-H′ direction.

According to an embodiment, an electronic device 101 according to an embodiment of the disclosure may include a multi-bar structure 232 and a lattice structure 233 stacked with the multi-bar structure. The lattice structure 233 may be formed of conductive material. Referring to FIG. 22A, slits S may be formed in the lattice structure 233 to support the display while reducing repulsive force. The slits S may be formed at positions corresponding to gaps of the metal bar structure.

According to another embodiment, the electronic device 101 may include a supporting member 234 including non-conductive material alternatively or additionally to the lattice structure 233. In FIG. 22B, according to an embodiment, an embodiment in which a supporting member 234 is disposed replacing the lattice structure 233 is illustrated. The supporting member 234 may have a flexible material. For example, the supporting member 234 may include a urethane supporting member or UV curing resin. The supporting member 234 may also include a material for molding. According to an embodiment, the supporting member 234 may be formed to fill gaps of the multi-bar structure 232. According to an embodiment, the supporting member 234 may be formed to wrap around the multi-bar structure 232. According to an embodiment, a configuration for disposing and electrically insulating the supporting member 234 between the multi-bar structure 232 and the display 231 may also be provided.

According to an embodiment, a configuration for electrical insulation may also be provided by forming a material of the guide rail 250 in contact with the multi-bar head 2321 from non-conductive material.

A communicable area between the antenna pattern and the external electronic device may be changed based on a position of the second housing part with respect to the first housing part.

An electronic device 101 according to an embodiment of the disclosure may include a housing 210 including a first housing part 201, and a second housing part 202 configured to move slidably with respect to the first housing part between a slide-in state and a slide-out state, a flexible display 231 comprising a first region and a second region, wherein at least part of the second region is drawn into or withdrawn from an internal space of the housing according to a movement of the second housing part with respect to the first housing part, a multi-bar structure 232 disposed to support the at least part of the second region of the flexible display and including a plurality of bars and a plurality of gaps being defined between two adjacent bars among the plurality of bars, wherein each of the plurality of bars includes a conductive material, and an antenna 310, including a plurality of first patterns 311 arranged parallel to a lengthwise direction of one of the plurality of bars. The antenna is configured to be disposed within a space formed between a part of the first region and a part of the second region of the flexible display in the slide-in state and each of the plurality of first patterns may be configured to be aligned with a corresponding gap of the plurality of gaps for radiating signal from the antenna through the plurality of gaps in the slide-in state.

According to an embodiment, when the electronic device is in the slide-in state, the plurality of bars and the plurality of first patterns may be alternately disposed along a first direction perpendicular to the lengthwise direction.

According to an embodiment, the multi-bar structure may be configured such that, as the second housing part moves in a second direction opposite to the first direction with respect to the first housing part, a first end portion 2321 of the multi-bar structure moves in the first direction, and an area in which the plurality of gaps is aligned with the plurality of first patterns may be substantially reduced.

According to an embodiment, when the electronic device is in the slide-in state, the fully retracted position of the second housing part may be set such that a first end portion 2321 of the multi-bar structure is disposed between an outermost portion of the plurality of first patterns and a 2-1 side wall 221a of the second housing part.

According to an embodiment, the antenna 310 may be configured to operate in a low frequency band of approximately 2 GHz or less. According to an embodiment, the antenna may include at least one of a wireless charging antenna for wireless charging, an NFC antenna for near field communication or an MST antenna for performing an electronic payment function.

According to an embodiment, the circuit board may further include a flexible printed circuit board (FPCB) 300 disposed between a battery 289 and the rear plate 215.

According to an embodiment, the antenna 310 may be disposed on a first surface of the FPCB which is disposed between the battery 289 and the rear plate 215.

According to an embodiment, when the electronic device is in the slide-in state, a center of each of the plurality of first patterns may be positioned at a position corresponding to a center of each of the plurality of gaps.

According to an embodiment, when the electronic device is in the slide-in state, at least two patterns of the plurality of first patterns may be positioned at a position corresponding to at least one of the plurality of gaps.

According to an embodiment, the electronic device may further include a plurality of second patterns extending from the plurality of first patterns and configured to form a loop with the plurality of first patterns.

According to an embodiment, when the electronic device is in the slide-in state, the electronic device may further include a third pattern positioned at a position corresponding to the plurality of bars.

According to an embodiment, the electronic device may further include a lattice structure disposed between the multi-bar structure and the display.

According to an embodiment, the multi-bar structure and the lattice structure may be configured to be electrically insulated from a rail structure supporting the multi-bar structure.

According to an embodiment, the multi-bar structure may include a multi-bar body and a multi-bar head, and the multi-bar body may be configured to be electrically insulated from the multi-bar head.

According to an embodiment, the electronic device may further include a protective layer disposed between the flexible display and the antenna. The protective layer may comprise a non-conductive material configured to minimize interference with signals transmitted or received by the antenna.

According to an embodiment, the multi-bar structure may be configured such that when the electronic device transitions from the slide-in state to a slide-out state, an overlapping area between the antenna and the multi-bar structure decreases to maintain antenna transmission/reception efficiency.

According to an embodiment, wherein the lattice structure may include slits formed at positions corresponding to the gaps between the plurality of bars of the multi-bar structure. The plurality of first patterns of the antenna may be aligned with both the gaps of the multi-bar structure and the slits of the lattice structure when the slidable electronic device is in the slide-in state.

A slidable electronic device according to an embodiment of the disclosure may include a housing including a first housing part, and a second housing part configured to move in a first direction with respect to the first housing part, a flexible display configured to be moved based on movement of the second housing part, a multi-bar structure configured to support at least a portion of the flexible display and including a plurality of bars, an antenna including a plurality of first patterns extending in a second direction perpendicular to the first direction, and a plurality of second patterns extending in a direction different from the plurality of first patterns. The antenna may be disposed inside the flexible display, and the plurality of first patterns of the antenna may be disposed at positions corresponding to gaps between two adjacent bars among the plurality of bars included in the multi-bar structure when the electronic device is in a slide-in state.

According to an embodiment, when the slidable electronic device is in the slide-in state, the plurality of bars and the plurality of first patterns may be alternately disposed along a first direction perpendicular to the lengthwise direction. The multi-bar structure may be configured such that, as the second housing part moves in a second direction opposite to the first direction with respect to the first housing part, a first end portion 2321 of the multi-bar structure moves in the first direction, and an area in which the plurality of gaps is aligned with the plurality of first patterns may be substantially reduced.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a housing including a first housing part and a second housing part configured to move slidably with respect to the first housing part between a slide-in state and a slide-out state;
a flexible display comprising a first region and a second region, wherein at least part of the second region is drawn into or withdrawn from an internal space of the housing according to a movement of the second housing part with respect to the first housing part;
a multi-bar structure disposed to support the at least part of the second region of the flexible display and including a plurality of bars and a plurality of gaps being defined between two adjacent bars among the plurality of bars, wherein each of the plurality of bars includes a conductive material; and
an antenna, including a plurality of first patterns arranged parallel to a lengthwise direction of one of the plurality of bars,
wherein the antenna is configured to be disposed within a space formed between a portion of the first region and a portion of the second region of the flexible display in the slide-in state and each of the plurality of first patterns is configured to be aligned with a corresponding gap of the plurality of gaps for radiating signal from the antenna through the plurality of gaps in the slide-in state.

2. The electronic device of claim 1,
wherein, when the electronic device is in the slide-in state, the plurality of bars and the plurality of first patterns are alternately disposed along a first direction perpendicular to the lengthwise direction, and
wherein, the multi-bar structure is configured such that, as the second housing part moves in the first direction with respect to the first housing part, a first end portion of the multi-bar structure moves in a second direction opposite to the first direction, and an area where the plurality of gaps and the plurality of first patterns are aligned is substantially reduced.

3. The electronic device of claim 1, wherein, when the electronic device is in the slide-in state, a fully retracted position of the second housing part is set such that a first end portion of the multi-bar structure is disposed between an outermost portion of the plurality of first patterns and a 2-1 side wall of the second housing part.

4. The electronic device of claim 1,
wherein the antenna is configured to operate in a low frequency band of approximately 2 GHz or less, and
wherein the antenna includes at least one of a wireless charging antenna for wireless charging, a near field communication (NFC) antenna for near field communicating or a magnetic secure transmission (MST) antenna for performing an electronic payment function.

5. The electronic device of claim 1, wherein a flexible printed circuit board (FPCB) disposed between a battery and a rear plate.

6. The electronic device of claim 5, wherein the plurality of first patterns of the antenna is disposed on a first surface of the FPCB which is disposed between the battery and the rear plate.

7. The electronic device of claim 1, wherein, when the electronic device is in the slide-in state, a center of each of the plurality of first patterns is positioned at a position corresponding to a center of each of the plurality of gaps.

8. The electronic device of claim 1, wherein, when the electronic device is in the slide-in state, at least two patterns of the plurality of first patterns are positioned at a position corresponding to at least one of the plurality of gaps.

9. The electronic device of claim 1, further comprising:
a plurality of second patterns extending from the plurality of first patterns and configured to form a loop with the plurality of first patterns.

10. The electronic device of claim 1, further comprising:
when the electronic device is in the slide-in state, a third pattern is positioned at a position corresponding to the plurality of bars.

11. The electronic device of claim 1, further comprising:
a lattice structure disposed between the multi-bar structure and the flexible display.

12. The electronic device of claim 11,
wherein the multi-bar structure and the lattice structure are configured to be electrically insulated from a rail structure supporting the multi-bar structure,
wherein the multi-bar structure includes:
a multi-bar body and a multi-bar head, and
wherein the multi-bar body is configured to be electrically insulated from the multi-bar head.

13. The electronic device of claim 1, further comprising:
a protective layer disposed between the flexible display and the antenna,
wherein the protective layer comprises a non-conductive material configured to minimize interference with signals transmitted or received by the antenna.

14. The electronic device of claim 1, wherein the multi-bar structure is configured such that when the electronic device transitions from the slide-in state to a slide-out state, an overlapping area between the antenna and the multi-bar structure decreases to maintain antenna transmission/reception efficiency.

15. The electronic device of claim 11,
wherein the lattice structure includes slits formed at positions corresponding to the gaps between the plurality of bars of the multi-bar structure, and
wherein the plurality of first patterns of the antenna are aligned with both the gaps of the multi-bar structure and the slits of the lattice structure when the slidable electronic device is in the slide-in state.

16. A slidable electronic device comprising:
a housing including a first housing part; and a second housing part configured to move in a first direction with respect to the first housing part;
a flexible display configured to be moved based on movement of the second housing part;
a multi-bar structure configured to support at least a portion of the flexible display and including a plurality of bars; and
an antenna including a plurality of first patterns extending in a second direction perpendicular to the first direction, and a plurality of second patterns extending in a direction different from the plurality of first patterns,
wherein the antenna is disposed inside the flexible display, and
wherein the plurality of first patterns of the antenna are disposed at positions corresponding to a plurality of gaps between two adjacent bars among the plurality of bars included in the multi-bar structure when the slidable electronic device is in a slide-in state.

17. The slidable electronic device of claim 16,
wherein when the slidable electronic device is in the slide-in state, the plurality of bars and the plurality of first patterns are alternately disposed along the first direction perpendicular to a lengthwise direction, and
wherein as the second housing part moves in a second direction opposite to the first direction with respect to the first housing part, a first end portion of the multi-bar structure moves in the first direction, and an area where the plurality of gaps and the plurality of first patterns are aligned is substantially reduced.

18. The slidable electronic device of claim 16, wherein when the slidable electronic device is in the slide-in state, a complete retraction position of the second housing part is set such that a first end portion of the multi-bar structure is disposed between an outermost portion of the plurality of first patterns and a 2-1 side wall of the second housing part.

19. The slidable electronic device of claim 16,
wherein the antenna is configured to operate in a low frequency band of approximately 2 GHz or less, and
wherein the antenna includes at least one of a wireless charging antenna for wireless charging, a near field communication (NFC) antenna for near field communication, or a magnetic secure transmission (MST) antenna for performing electronic payment functions.

20. The slidable electronic device of claim 16, further comprising:
a third pattern disposed at positions corresponding to the plurality of bars when the slidable electronic device is in the slide-in state.
